(19) United States
(12) Patent Application Publication
(10) Pub. No.: US 2026/0188285 A1
(43) Pub. Date: Jul. 2, 2026

(54) ADAPTER AND ASSEMBLY FOR INTERCHANGEABLE TUNING HEADS

(71) Applicant: Tune Up LLC, San Diego, CA (US)

(72) Inventors: Alan Esses, San Diego, CA (US); Joshua Barforough, San Diego, CA (US)

(73) Assignee: Tune Up LLC, San Diego, CA (US)

(21) Appl. No.: 19/433,529

(22) Filed: Dec. 26, 2025

Related U.S. Application Data
(60) Provisional application No. 63/739,014, filed on Dec. 26, 2024.

(51) Int. Cl. G10D 3/14

(52) U.S. Cl. CPC G10D 3/14

(57) ABSTRACT

A tuning head adapter and assembly providing a new functional and cosmetic look for tuning heads across stringed instruments is disclosed. The adapter for a tuning shaft of a stringed instrument includes a body having: a first opening disposed at a proximal end of the body, the first opening configured to receive the tuning shaft; and a second opening disposed at a distal end of the body or on a portion of the body between the proximal end and the distal end, where the second opening is configured to receive a fastener for coupling the adapter to the tuning shaft. An outer surface of the body of the adapter corresponds to an inner surface of a cavity of the tuning head, such that the adapter is configured to at least partially nest within the cavity of the tuning head.

### CROSS-REFERENCE TO RELATED APPLICATION

This application is entitled to the benefit of and claims priority to co-pending U.S. Provisional Patent Application Ser. No. 63/739,014 filed Dec. 26, 2024 and entitled “TUNING HEAD ADAPTER.” The entire disclosure and contents of this prior filed application are hereby incorporated by reference herein in its entirety.

### TECHNICAL FIELD

The present invention relates generally to mechanisms and accessories for stringed instruments. More specifically, this disclosure relates to tuning mechanisms and tuning heads (or machine heads) of string instruments that involve a tuning shaft (or tuning peg).

### BACKGROUND

Tuning heads on stringed instruments are used to adjust the tension of the strings of the stringed instrument in order to “tune” them appropriately. By twisting the tuning heads in either direction, the tension, and thus the resulting tune of that string, changes. Tuning heads typically include a tuning peg and a screw that screws the tuning head to the tuning peg, which in turn is connected to a tuning mechanism, such as a pinion and worm gear, that rotates to adjust string tension to a desired frequency. Tuning heads are typically designed to allow a user to easily twist the tuning head to make adjusting the tensions of the strings easier. However, depending on the stringed instrument being used and the size and shape of the tuning mechanism and tuning peg, a user does not have much choice, if any, in terms of what kind and style of tuning head to use.

### SUMMARY

There is therefore a need to provide a new functional and cosmetic look for tuning heads across stringed instruments. By providing a universal attachment to hold the tuning head in place, the present disclosure can provide “plug-and-play” options for the cosmetic side of the tuning head.

As described herein, a tuning head adapter and assembly providing a new functional and cosmetic look for tuning heads across stringed instruments is disclosed. The disclosed adapter and assembly provide a universal attachment to hold the tuning gear, and in particular the tuning head, of stringed instruments in place. Moreover, the disclosed adapter and assembly can provide “plug-and-play” options for the cosmetic side of the tuning head of stringed instruments.

The disclosed adapter and assembly also reduce or eliminate the need to unscrew, or unfasten, the tuning head from the tuning mechanism of the stringed instrument. The disclosed adapter and assembly provide a mechanism that is modular to any sized or shaped tuning head. Another advantage of the disclosed adapter and assembly is that it is economical to manufacture and easy to install. Further, the disclosed adapter and assembly can be installed using minimal effort, often eliminating the need for any additional tools or instruments.

Additionally, the disclosed adapter and assembly provide tailored aesthetics, allowing a user to select shapes, finishes, and styles that match the look of the stringed instrument or the personal preference of the user, or that prevent clutter on the headstock of the stringed instrument. The disclosed adapter and assembly can feature lighter materials to reduce weight at the headstock of the stringed instrument, thereby preventing “neck dive” and improving the feel and balance of the stringed instrument. Another advantage of the disclosed adapter and assembly is that it can offer a smoother tuning feel by standardizing the height of width of the tuning mechanism. For example, the disclosed adapter and assembly can appeal to people with different medical conditions, making the tuning head easier to turn or softer to touch based on different needs. In other words, the disclose adapter and assembly can be ergonomically designed to allow for easy rotation, such as reducing the required torque to turn a tuning head, resulting in easy tuning capabilities. Further, the disclosed adapter and assembly provide greater tuning stability, thereby increasing the longevity and requiring less maintenance over the life of the stringed instrument.

Advantages of the present disclosure include a quick-release mechanism for the tuning head of the stringed instrument, allowing the tuning head to be easily removed and replaced with another tuning head, thus providing full customizability options for the tuning head attachment. In accordance with an embodiment of the disclosure, an adapter for a tuning shaft of a string instrument includes a body having: a first opening disposed at a proximal end of the body, the first opening configured to receive the tuning shaft; and a second opening disposed at a distal end or on a portion of the body between the proximal end and the distal end, the second opening configured to receive a fastener for coupling the adapter to the tuning shaft. The outer surface of the body of the adapter corresponds to an inner surface of a cavity of the tuning head, such that the adapter is configured to at least partially nest within the cavity of the tuning head.

In accordance with another embodiment of the disclosure, a tuning head adapter assembly for a tuning shaft of a stringed instrument includes a tuning head; and an adapter configured to removably couple to the tuning head and including a body. The body includes a proximal end including a first opening configured to receive the tuning shaft; and a distal end including a second opening configured to receive a fastener for coupling the adapter to the tuning shaft.

In accordance with another embodiment of the present disclosure, a tuning head adapter includes a first opening configured to receive a tuning peg and a second opening configured to receive a fastener for fastening the adapter to the tuning peg. An outer surface of the adapter corresponds to an inner surface of a cavity of a tuning head, such that the adapter is configured to at least partially nest within the cavity of the tuning head.

Various other features, embodiments, and alternatives of the present disclosure should be apparent from the following detailed description taken together with the accompanying drawings. It should be understood, however, that the detailed description and specific examples, while indicating some of the embodiments of the disclosure, are given by way of illustration and not limitation. Many changes and modifications could be made within the scope of the present disclosure without departing from the spirit thereof, and the present disclosure includes all such changes and modifications.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The embodiments of the disclosure are illustrated in the accompanying drawings, in which like reference numerals represent like parts throughout, and in which:

FIG. 1A is an exploded perspective view of a conventional tuning head assembly, including a tuning head, a tuning mechanism, a tuning shaft, a fastener, and a headstock of a stringed instrument, showing the configuration of each corresponding component before installation.

FIG. 1B is an exploded perspective view of the conventional tuning head assembly of FIG. 1A showing the tuning head disposed on the tuning shaft.

FIG. 1C is an exploded perspective view of the conventional tuning head assembly of FIG. 1A showing the fastener inserted into the tuning head and into the tuning shaft, thereby securing the tuning head to the tuning mechanism.

FIG. 2 is a front perspective view of an adapter for a tuning shaft of a stringed instrument, according to one embodiment.

FIG. 3 is a cross-sectional perspective view of the adapter of FIG. 2.

FIG. 4 is a bottom perspective view of the adapter of FIG. 2.

FIG. 5 is a front view of the adapter of FIG. 2 showing the internal configuration of the first opening and the second opening, where the adapter of FIG. 2 has a width and a height, where the height includes a first height and a second height.

FIG. 6 is a lateral view of the adapter of FIG. 2.

FIG. 7A is a bottom perspective view of the adapter of FIG. 2 showing the first opening as the volume between the inner surfaces of the appendages.

FIG. 7B is a bottom view of the adapter of FIG. 2 showing the overlap of the proximal end to the distal end (bolded dotted lines of FIG. 7B).

FIG. 8A is a top view of the adapter of FIG. 2 showing the second opening.

FIG. 8B is a top view of the adapter of FIG. 2 showing the overlap of the distal end to the proximal end (bolded dotted lines of FIG. 8B).

FIG. 9A is a front perspective view of an “M-shaped” adapter, according to one embodiment.

FIG. 9B is a front perspective view of the “M-shaped” adapter of FIG. 9A showing the deformation, or deflection, of the appendages.

FIG. 10A illustrates the two states of the “M-shaped” adapter of FIG. 9A responsive to a downward force, according to one embodiment.

FIG. 10B illustrates the two states of the “M-shaped” adapter of FIG. 9A responsive to an axial translation of a fastener, according to one embodiment.

FIG. 11 is a perspective view of a “prism-shaped” adapter for a d-shaft tuning peg, according to one embodiment.

FIG. 12 is a cross-sectional view of the “prism-shaped” adapter of FIG. 11 showing the inside contour, such as the inner surface, according to one embodiment.

FIG. 13 is a top view of the “prism-shaped” adapter of FIG. 11 showing a double D-shaft contour, where the first opening (outermost circumferential dotted line of FIG. 13) is larger than the second opening, according to one embodiment.

FIG. 14A is an exploded perspective view of a tuning head adapter assembly, including the adapter of FIG. 2, a custom tuning head, a tuning mechanism, a tuning shaft, a fastener, a magnet, and a headstock of a stringed instrument, according to one embodiment.

FIG. 14B is an exploded perspective view of the tuning head adapter assembly of FIG. 14A showing the adapter of FIG. 2 disposed on the tuning shaft of the tuning mechanism.

FIG. 14C is an exploded perspective view of the tuning head adapter assembly of FIG. 14A showing the fastener inserted into the second opening of the adapter of FIG. 2 and into the tuning shaft, thereby securing the adapter to the tuning mechanism.

FIG. 14D is an exploded perspective view of the tuning head adapter assembly of FIG. 14A showing the magnet disposed on the fastener.

FIG. 14E is a perspective view of the tuning head adapter assembly of FIG. 14A showing the custom tuning head magnetically coupled to the adapter of FIG. 2.

FIG. 15 is a perspective view of the tuning head adapter assembly of FIG. 14A with an alternate custom tuning head, according to one embodiment.

FIG. 16 is a bottom perspective view of the custom tuning head of FIG. 14A showing an aperture, or a receivable portion, including a complimentary surface on a proximal end, according to one embodiment.

FIG. 17 is a side view of the custom tuning head of FIG. 14A showing the contour, or the shape, of the receivable portion including the complimentary surface.

FIG. 18A is a bottom perspective view of the custom tuning head of FIG. 14A showing the adapter of FIG. 2 disposed within the receivable portion.

FIG. 18B is a cross-section view of the configuration of FIG. 18A.

FIG. 19A is an exploded perspective view of a tuning head adapter assembly showing the fastener disposed within the adapter of FIG. 2, according to one embodiment.

FIG. 19B is perspective view of the tuning head adapter assembly of FIG. 19A showing the adapter of FIG. 2 coupled to the tuning shaft using the fastener.

FIG. 20 is a side perspective view of a “side-hole” adapter for a tuning shaft of a stringed instrument, according to one embodiment.

FIG. 21 is a bottom view of the “side-hole” adapter of FIG. 20 showing the inner channel.

FIG. 22 is a front view of the “side-hole” adapter of FIG. 20 showing the internal configuration of the inner surface (internal dotted lines of FIG. 22), where the adapter of FIG. 20 has a width and a height.

FIG. 23A is a side view of a fastener in relation to the “side-hole” adapter of FIG. 20, according to one embodiment.

FIG. 23B is a bottom perspective view of a fastener in relation to the “side-hole adapter of FIG. 20, showing the inner surface and inner channel of the “side-hole” adapter.

FIG. 24A is an exploded perspective view of a tuning head adapter assembly, including the “side-hole” adapter of FIG. 20, a custom tuning head, a tuning mechanism, a tuning shaft, a fastener, a magnet, and a headstock of a stringed instrument, according to one embodiment.

FIG. 24B is an exploded perspective view of the tuning head adapter assembly of FIG. 24A showing the “side-hole” adapter of FIG. 20 disposed on the tuning shaft of the tuning mechanism.

FIG. 24C is an exploded perspective view of the tuning head adapter assembly of FIG. 24A showing the fastener inserted into the second opening of the “side-hole” adapter of FIG. 20, clamping the fastener into the tuning shaft, thereby securing the “side-hole” adapter to the tuning mechanism.

FIG. 24D is an exploded perspective view of the tuning head adapter assembly of FIG. 24A showing the magnet disposed on the fastener.

FIG. 24E is a perspective view of the tuning head adapter assembly of FIG. 24A showing the custom tuning head magnetically coupled to the “side-hole” adapter of FIG. 20.

FIG. 25 shows various configurations and examples of different types of custom tuning heads, according to multiple embodiments.

While the disclosed devices and methods are representative of embodiments in various forms, specific embodiments are illustrated in the drawings (and are hereafter described), with the understanding that the disclosure is intended to be illustrative and is not intended to limit the claim scope to the specific embodiments described and illustrated herein.

### DETAILED DESCRIPTION

The present disclosure and the various features and advantageous details thereof are explained more fully with reference to the non-limiting embodiments described in detail in the following description.

Terms used in the specification such as “first,” “second,” and the like, may be used to describe various components, but the components are not to be interpreted as limited by the terms. The terms are used only to distinguish one component from another component. For example, a first component may be named a second component and the second component may also be similarly named the first component, without departing from the scope of the present disclosure. The term “and/or” includes a combination of a plurality of related described items or any one of the plurality of related described items.

Terms used in the present specification are used only in order to describe specific embodiments rather than limiting the present disclosure. Singular forms are intended to include plural forms unless the context clearly indicates otherwise. It should be further understood that the terms “comprises” or “have” and the like used in this specification specify the presence of stated features, steps, operations, components, parts mentioned in this specification, or a combination thereof. Such terms do not preclude the presence or addition of one or more other features, numerals, steps, operations, components, parts, or a combination thereof.

Unless indicated otherwise, it should be understood that all the terms used in the specification including technical and scientific terms have the same meaning as those that are generally understood by those having ordinary skill in the art. Terms generally used and defined by a dictionary should be interpreted as having the same or consistent meanings as those within a context of the related art. Such terms should not be interpreted as having ideal or excessively formal meanings unless being clearly defined otherwise in the present specification.

When a component, device, element, unit, member, or the like of the present disclosure is described as having a purpose or performing an operation, function, or the like, the component, device, element, member, or unit should be considered herein as being “configured to” meet that purpose or to perform that operation or function.

For clarity of disclosure, the terms “proximal” and “distal” are defined herein relative to a headstock of a stringed instrument. The term “proximal” refers the position of an element closer to the headstock of a stringed instrument. The term “distal” refers to the position of an element further away from the headstock of a stringed instrument. In addition, the terms “upper,” “lower,” “lateral,” “transverse,” “bottom,” “top,” are relative terms to provide additional clarity to the figure descriptions provided below. The terms “upper,” “lower,” “lateral,” “transverse,” “bottom,” “top,” are thus not intended to unnecessarily limit the invention described herein.

A “stringed instrument,” as used in this specification, is defined herein as a device or apparatus designed to produce musical tones or sounds primarily through the vibration of one or more tensioned flexible filaments (or “strings”). The “stringed instrument” may include, but is not limited to, hybrid instruments where a vibrating string system is used in combination with secondary sound generation or transduction methods. The “stringed instrument” may further include, but is not limited to, plucked and strummed instruments (e.g., guitar, bass guitar, lute, harp, or the like), bowed instruments (e.g., violin, viola, cello, bass, or the like), struck instruments (e.g., piano, zithers, or the like), or their electric counterparts.

The present disclosure aims to solve problems existing in the prior art. Firstly, conventional tuning head assemblies lack full customizability of a tuning head, requiring removal of a screw or a fastener to replace the tuning head. The present disclosure provides a mechanism for easy removal of the tuning head without the need for additional tools. In other words, the disclosed adapter and assembly provides a universal adapter, where the tuning head can be easily swapped and adjusted without compromising the tuning stability, performance, or functionality of the stringed instrument. Secondly, conventional tuning head assemblies lack a standardized tuning shaft size, further preventing the range of possible replacements for the tuning head. The present disclosure provides a universal adapter that can be disposed over a tuning shaft of any size or shape. The disclosed adapter is configured to connect to a corresponding, or complementary, tuning head that is fully customizable, allowing for a wide range of stylistic, convenient, and/or stable tuning head replacements. In other words, the disclosed adapter only needs to be fastened to the tuning shaft of the stringed instrument, and the corresponding tuning head can be replaced with improved ease. The disclosed adapter and assembly thereby provide the replacement of the tuning head to accommodate the aesthetic and/or style of the stringed instrument or the personal preference of the user, such as user-defined customization, including, but not limited to, material, shape, color, or design of the tuning head and the adapter. Thirdly, conventional tuning head assemblies feature the same, or substantially the same, tuning heads on the headstock of the stringed instrument. The disclosed adapter and assembly provide the ability to replace one or more of the tuning heads on the headstock, thereby diversifying the tuning head designs on the headstock.

Replacement of conventional tuning heads often requires complete and full replacement of the entire tuning head assembly. For example, conventional tuning head assemblies made for replacement require drilling additional holes into the headstock, which permanently alter the stringed instrument. The present disclosure provides a mechanism for replacement of the tuning head without any additional permanent, physical alterations to the stringed instrument.

Another problem of conventional tuning head assemblies is that they contribute to “neck dive” of the stringed instrument. “Neck dive” occurs when the headstock of the stringed instrument dips downward when wearing the stringed instrument with or without a strap. The result is a heavy and unbalanced feeling on the neck of the stringed instrument, creating an unpleasant playing experience due to the unbalanced weight distribution of the stringed instrument. The present disclosure can feature lighter materials to reduce weight at the headstock of the stringed instrument, thereby preventing the “neck dive” and improving the feel and balance of the stringed instrument.

Additionally, conventional tuning head assemblies can feature bulky tuning heads that interfere with the playing experience of the stringed instrument. For example, in addition to “neck dive,” the size and weight of the tuning head, and therefore the weight of the headstock, can affect how the vibrations of the string interact with the neck of the stringed instrument. In other words, the increased weight of the tuning head can add inertia to the headstock, thereby increasing sustain and dampening high frequencies. The disclosed adapter and assembly provide lighter options for tuning heads, thereby allowing the neck of the stringed instrument to vibrate more freely and increasing clarity and brightness of the emitted sound. In addition, bulkier tuning heads can look out of place on smaller headstocks and interfere with each other when the tuning heads are spaced closely together. The present disclosure provides easy replacement of existing tuning heads with more compact tuning head designs, thereby minimizing interference between each respective tuning head on the headstock. The disclosed adapter and assembly further provide the ability to integrate different materials (e.g., lighter and/or softer materials) into tuning head assemblies to appeal to people with different medical conditions, making the tuning head easier to turn or softer to touch based on different needs. In other words, the disclosed adapter and assembly can be ergonomically designed to allow for easy rotation, such as reducing the required torque to turn a tuning head, resulting in easy tuning capabilities.

Further, another problem of conventional tuning head assemblies is that they can lack sufficient durability, particularly in stringed instruments at lower price points. In other words, tuning heads made from cheaper material and lacking structural integrity can be prone to breakage, thereby requiring replacement. The disclosed adapter and assembly provide a wide range of possible material compositions and shapes for both the adapter and the tuning head, thereby providing more durable and/or higher quality tuning head replacements for these lower-priced stringed instruments.

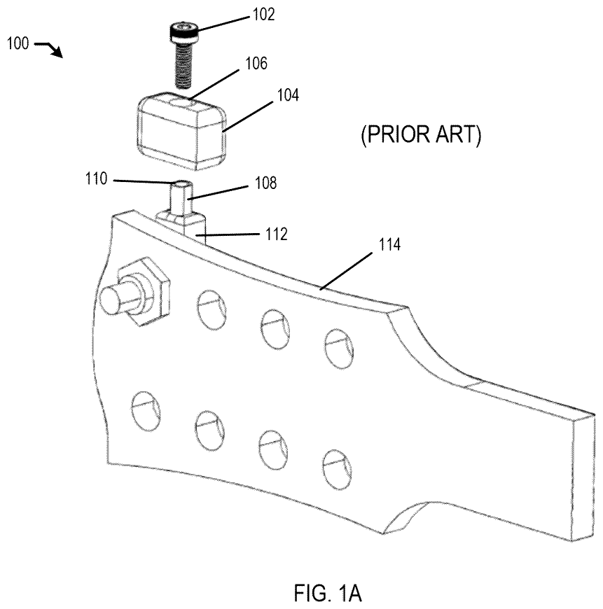

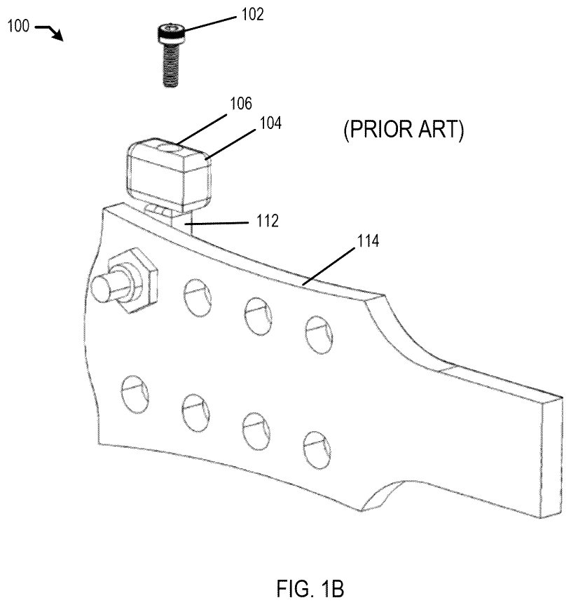

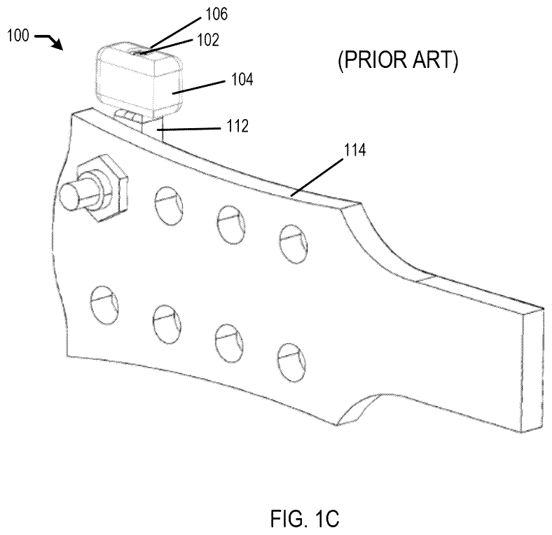

Referring now to the drawings, FIG. 1A is an exploded perspective view of a conventional tuning head assembly 100, including a tuning head 104, a tuning mechanism 112, a tuning shaft 108, a fastener 102, and a headstock 114 of a stringed instrument (not shown), showing the configuration of each corresponding component before installation. The tuning mechanism 112 is coupled to a receivable portion of the headstock 114 of the stringed instrument. The tuning mechanism 112 includes a tuning shaft 108 extending longitudinally from a distal end of the tuning mechanism 112. The tuning shaft 108 includes an aperture 110 configured to receive the fastener 102. The tuning head 104 also includes an aperture 106 configured to receive the fastener 102. The tuning head 104 is configured to be disposed on the tuning shaft 108, as shown in FIG. 1B, and coupled to the tuning shaft 108 by the fastener 102, as shown in FIG. 1C.

FIG. 1B is an exploded perspective view of the conventional tuning head assembly 100 of FIG. 1A showing the tuning head 104 disposed on the tuning shaft 108. FIG. 1C is an exploded perspective view of the conventional tuning head assembly 100 of FIG. 1A showing the fastener 102 inserted into the aperture 106 of the tuning head 104 and into the aperture 110 of the tuning shaft 108, thereby securing the tuning head 104 to the tuning mechanism 112.

As illustrated, the conventional tuning head assembly 100 of FIGS. 1A-C suffers from at least one important limitation, namely the inability to easily remove the tuning head 104 without removal of the fastener 102.

In contrast to the foregoing, the present disclosure provides an interchangeable adapter and assembly for easy removal of the fastener and for complete customization of the tuning head.

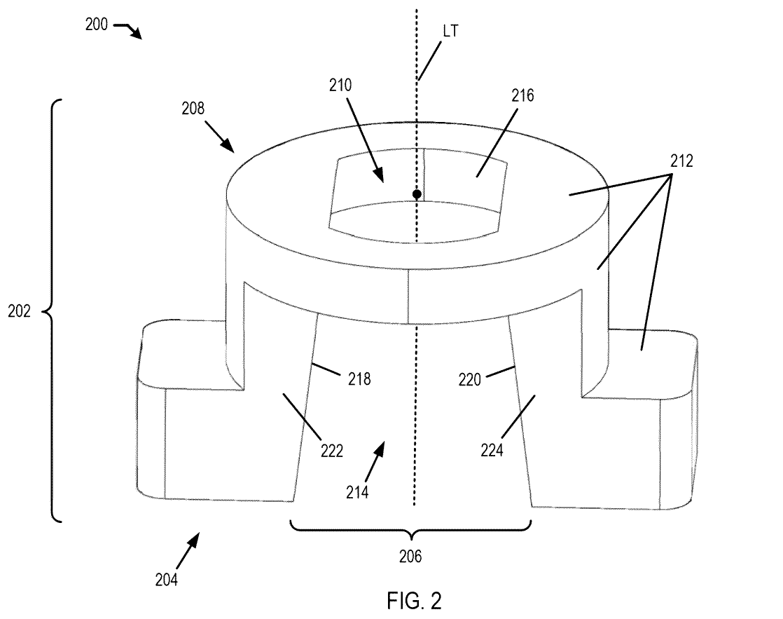

FIG. 2 is a front perspective view of an adapter 200 for a tuning shaft (not shown) of a stringed instrument (not shown), according to one embodiment of the present disclosure. FIG. 2 illustrates the adapter 200 without attachment to a tuning shaft, fastener, or tuning head, for clarity. The adapter 200 includes a body 202 extending along a longitudinal axis LT. The longitudinal axis LT may be imaginary (or a conceptual line) or may correspond to a physical component of the adapter 200. The body 202 includes a proximal end 204 including a first gap or opening 206 configured to receive the tuning shaft (not shown). The body 202 further includes a distal end 208 and an outer surface or a coupling surface 212 configured to removably engage a complementary surface (not shown) of a tuning head (not shown). In other words, the outer or complementary surface of the body 202 corresponds to an inner surface of a cavity of a tuning head, such that the body 202 is configured to at least partially nest within the tuning head. The body 202 further includes a second opening 210 configured to receive a fastener (not shown) for coupling the adapter 200 to the tuning shaft (not shown). The second opening 210 may be disposed on or at the distal end 208 or on a portion of the body 202 between the proximal end 204 and the distal end 208. In one example, at least a portion of the distal end 208 may be circular in cross-section. For example, at least a portion of the coupling surface 212 of the distal end 208 may be circular in cross-section. The circular cross-section may reduce the cost and/or time required for manufacture of the adapter 200. The coupling surface 212 of the adapter 200 may allow for “plug-and-play” capabilities of the tuning head. The adapter 200 may reduce the form factor of the tuning head, allowing for a slimmer tuning head. The adapter 200 may be more easily manufactured, thus improving overall product efficiency.

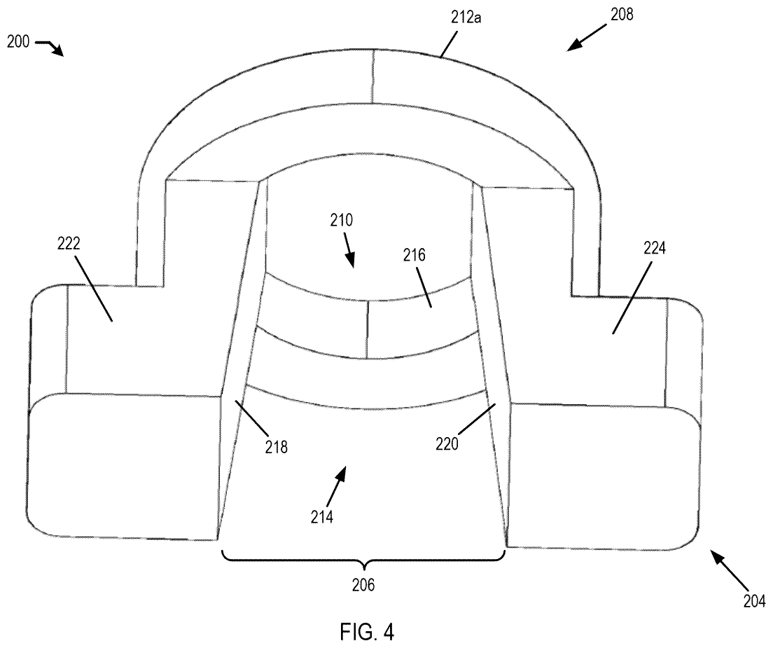

The body 202 of the adapter 200 may further include an inner channel 214 defined (or bound) by an inner surface (or surfaces) 216, 218, 220 extending from the first opening 206 to the second opening 210, as shown and discussed further in FIGS. 4, 5, 7A, and 8B below. The inner channel 214 may be a channel of any size or shape. For example, the inner channel 214 may have varying cross-sectional dimensions (e.g., diameter, length, and/or width) along the entire length (or height respective to the longitudinal axis LT) of the inner channel 214. In this way, the inner channel 214 is able to receive different tuning pegs or shafts of varying sizes and shapes. The inner surfaces 216, 218, 220 that define the inner channel 214 may include additional reinforcement mechanisms, such as specific topography, to further stabilize the coupling between the adapter 200 and the tuning shaft. For example, the addition reinforcement mechanisms (or specific topography) may include reinforcing ribs, webs, gussets, bars, mesh, wires, inserts, bushings, threads, varying wall thickness (or contour), material selection and composition, coatings, plating, interlocking (or sandwich) structures, or the like.

The adapter 200 may further include proximally extending appendages 222, 224 (e.g., at least two proximally extending appendages 222, 224). In the example shown in FIG. 2, these appendages 222, 224 extend away from the distal end 208 of the body 202 of the adapter 200 in a proximal direction. Portions of the appendages 222, 224 may also extend away from the longitudinal axis LT (e.g., in a direction transverse or perpendicular to the longitudinal axis LT). The adapter 200 may include any number of proximally extending appendages 222, 224. The proximally extending appendages 222, 224 may be any shape or size. For example, as illustrated in FIG. 2, the proximally extending appendages 222, 224 may be “L-shaped.” The proximally extending appendages 222, 224 may include inner surfaces 218, 220 (or a respective inner surface 218, 220). The inner surfaces 218, 220 of the proximally extending appendages 222, 224 may be any shape, size, or contour. For example, as illustrated in FIG. 2, the inner surfaces 218, 220 of the proximally extending appendages 222, 224 may be rectangular and flat. However, in another example, the inner surfaces 218, 220 of the proximally extending appendages may be rounded. In another embodiment, a respective inner surface 218, 220 of a respective proximally extending appendage 218, 220 may be one or more surfaces, where each of the one or more surfaces may have the same or different contour from another one of the one or more surfaces.

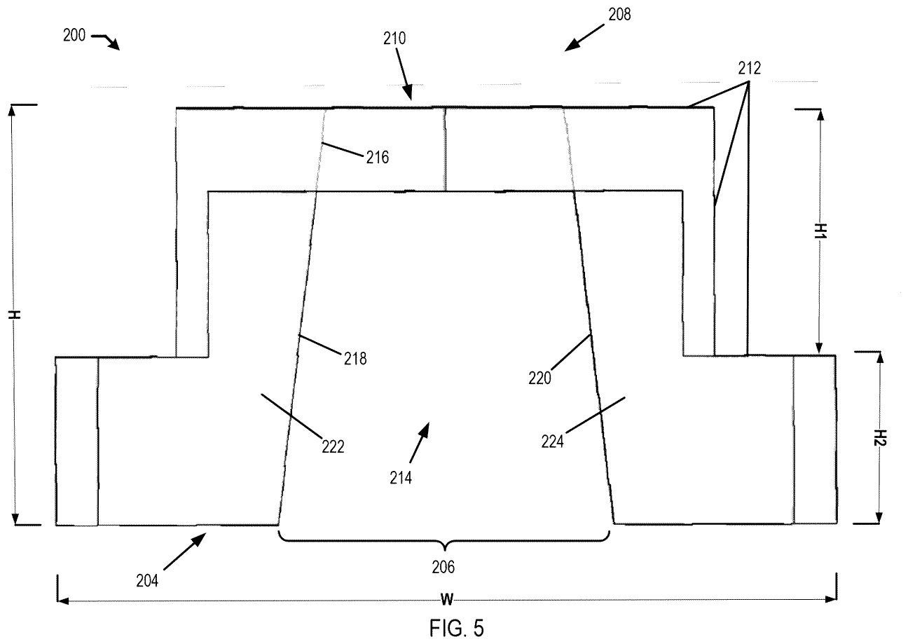

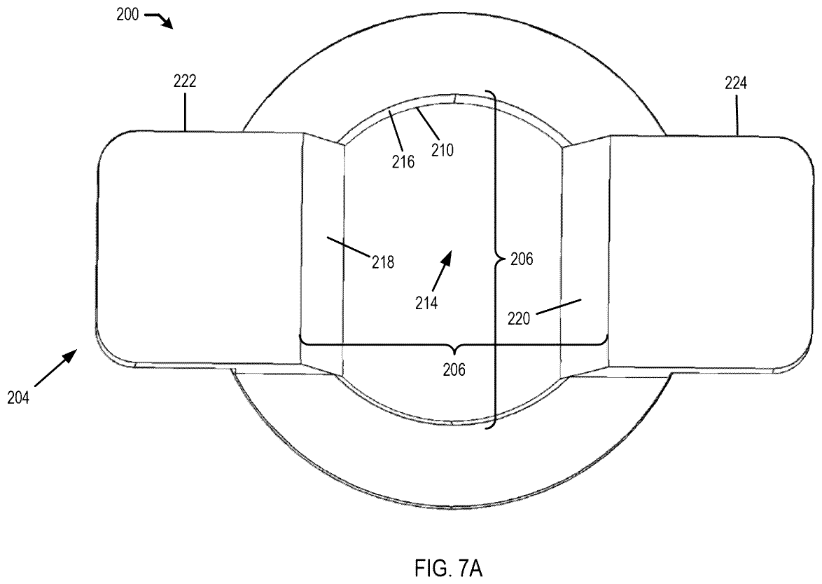

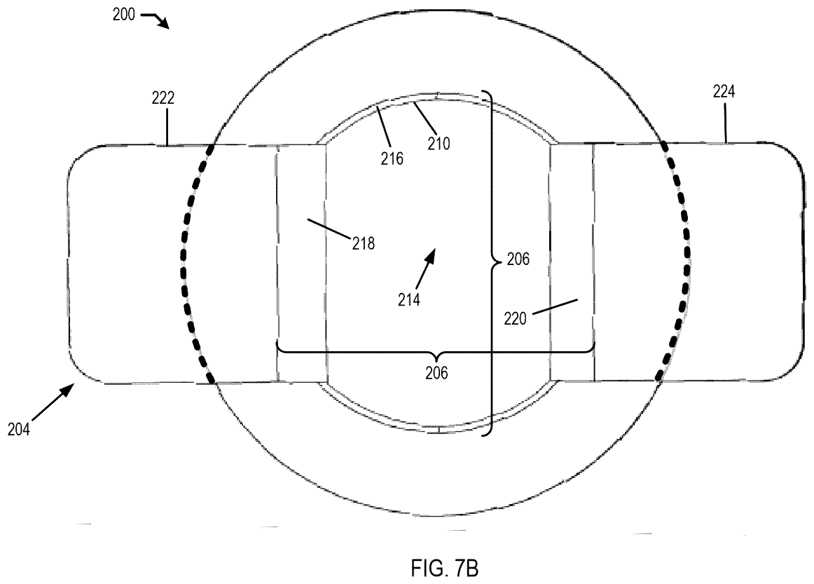

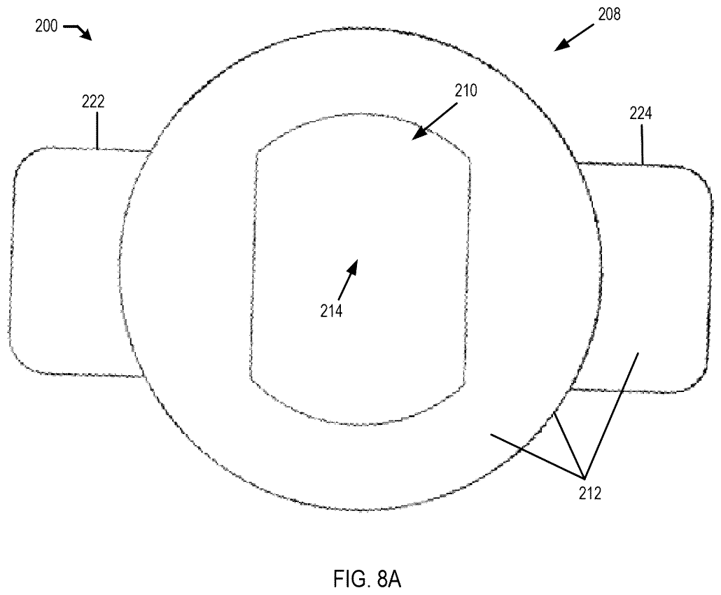

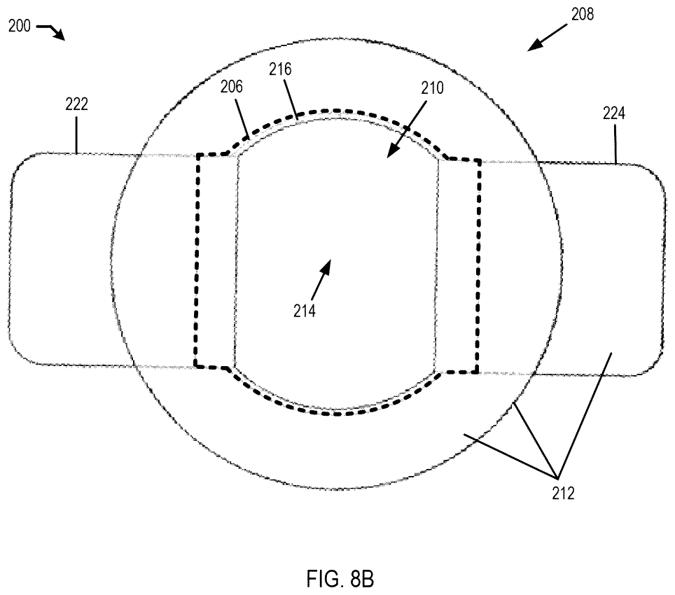

FIG. 4 is a bottom perspective view of the adapter 200 of FIG. 2. FIG. 5 is a front view of the adapter 200 of FIG. 2 showing the internal configuration of the first opening 206 and second opening 210. As shown in FIGS. 4 and 5, the inner channel 214 of the adapter 200 may have a cross-sectional area that gradually reduces along a portion (or at least a portion) of the length (or height respective to the longitudinal axis LT) of the inner channel 214 from the first opening 206 to the second opening 210, further described below in FIGS. 7A and 8B. For example, the inner channel 214 may have a tapered contour in at least a portion of the inner channel 214. In other words, the inner channel 214 may have a cross-sectional area that gradually (or substantially) reduces along the length (or height respective to the longitudinal axis LT) from the first opening 206 to the second opening 210, such that the first opening 206 may be larger than the second opening 210. For example, the inner channel 214 may have a funnel shape, which increases in diameter in one direction (e.g., the first opening 206 may have a larger diameter than the second opening 210). The inner channel 214 may have an interior contour that matches the geometry of the tuning shaft (not shown) in order to fit varied shapes and size of the tuning shaft.

FIG. 5 further illustrates the adapter 200 having a width W and a height H, where the height H includes a first height H1 and a second height H2. The width W of the adapter 200 is measured across the widest opposing external surfaces of the body 202 of the adapter 200, orthogonal to the longitudinal axis LT (e.g., orthogonal to the height H). The width W may be in a range from about 7.0 millimeters (mm) to 20.0 mm (e.g., about 7.0 mm to 16.0 mm, about 7.0 mm to 12.0 mm, about 7.0 mm to 10.00 mm, or the like). The width W may be any width greater than a width of a tuning shaft. The height H of the adapter is measured across the lowest-to-highest opposing external surfaces of the body 202 of the adapter 200, in line with the longitudinal axis LT (e.g., orthogonal to the width W), such as the overall height between the two most extreme opposing horizontal planes. In other words, the height H of the adapter 200 is measured from a base plane (e.g., lowest point) to the highest point of the external surface of the body 202. The height H may be in a range from about 3.0 mm to 7.0 mm (e.g., about 3.0 mm to 6.0 mm, about 3.0 mm to 5.0 mm, or the like). The height H may be any height equal to or less than a height of a tuning shaft. The height H may be greater than or less than the width W. For example, the height H may be approximately one-half the width W. The height H includes a first height H1 and a second height H2. The first height H1 and the second height H2 may include heights of portions of the proximally extending appendages 222, 224. For example, where the proximally extending appendages are “L-shaped,” the first height H1 may include a height of a substantially vertical portion of the external surface of the “L-shape” of the body 202. The first height H1 may be in a range from about 0.5 mm to 6.5 mm (e.g., about 0.5 mm to 5.0 mm, about 0.5 mm to 4.0 mm, about 0.5 mm to 3.0 mm, or the like). For example, where the proximally extending appendages are “L-shaped,” the height H2 may include a height of a substantially laterally extending base portion of the external surface of the “L-shape” of the body 202. The second height H2 may be in a range of about 0.5 mm to 6.5 mm (e.g., about 0.5 mm to 5.0 mm, about 0.5 mm to 4.0 mm, about 0.5 mm to 3.0 mm, or the like). The first height H1 may be greater than or less than the second height H2.

Referring back to FIG. 2, the first opening 206 and the second opening 210 may be concentric (or concentric with the longitudinal axis LT). For example, the first opening 206 and the second opening 210 may share a common central axis (e.g., longitudinal axis LT). However, the first opening 206 and the second opening 210 are not limited to the aforementioned configuration. For example, the first opening 206 and the second opening 210 may be displaced from each other at different distances (e.g., length and/or width) from the central axis (e.g., longitudinal axis LT). In other words, the first opening 206 may be displaced at a respective distance (e.g., length and/or width) from the central axis (e.g., longitudinal axis LT) that is different from the second opening 210.

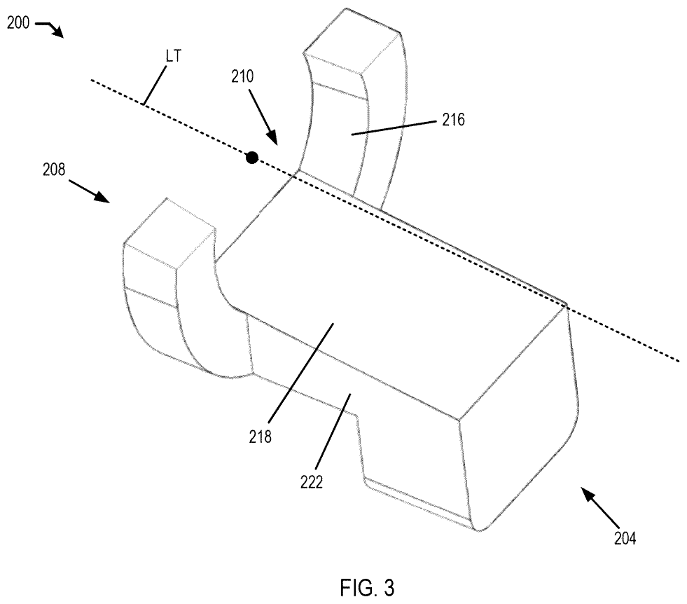

FIG. 3 is a cross-sectional perspective view of the adapter 200 of FIG. 2. FIG. 3 illustrates the inner surface 218 of one of the proximally extending appendages 222 and the inner surface 216 of the distal end 208 that is proximate to the second opening 210. The inner surface 216 of the distal end 208 that is proximate to the second opening 210 may be the inner surface of the body 202 that has a different contour than the inner surfaces 218, 220 of the proximally extending appendages 222, 224, as shown further in FIG. 4 and 7A-B. For example, as illustrated, the inner surface 216 of the distal end 208 may be substantially rounded, whereas the inner surfaces 218, 220 of the proximally extending appendages 222, 224 are flat. Further, in one embodiment, for example, the inner surface 216 of the distal end 208 may not have a tapered contour, whereas the inner surfaces 218, 220 of the proximally extending appendages 222, 224 may have a tapered contour. In yet a different embodiment, the inner surface 216 of the distal end 208 may have a tapered contour, whereas the inner surfaces 218, 220 of the proximally extending appendages 222, 224 may not have a tapered contour.

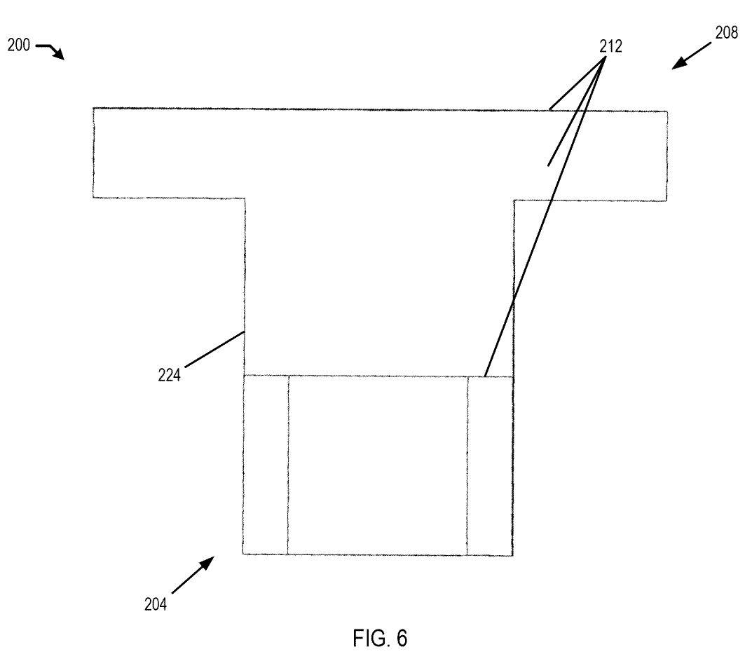

FIG. 6 is a lateral view of the adapter 200 of FIG. 2. FIG. 6 illustrates the coupling surface 212 of the body 202. For example, the coupling surface 212 may be one or more surfaces of the body 202. As illustrated in FIG. 6, a first portion 212 of the coupling surface 212 may be the distal end 208 of the body 202. A second portion 212 of the coupling surface 212 may be the distal outer portion of the distal end 208 of the body 202. A third portion 212 of the coupling surface 212 may be the distal outer portion of one or more of the proximally extending appendages 222, 224 (e.g., the distal outer portion of the proximally extending appendage 224).

FIG. 7A is a bottom perspective view of the adapter 200 of FIG. 2 showing the first opening 206 as the volume between the inner surfaces 218, 220 of the appendages 222, 224. FIG. 7B is a bottom view of the adapter of FIG. 2 showing the overlap of the proximal end 204 to the distal end 208 (as shown by the bolded dotted lines in FIG. 7B). As illustrated in FIGS. 7A-B, the first opening 206 may be a cavity defined by a volume (e.g., height, width, and length) between inner surfaces 218, 220 of the proximally extending appendages 222, 224 (e.g., at least two proximally extending appendages 222, 224). For example, the cavity defined by the volume (e.g., height, width, and length) between the inner surfaces 218, 220 of the proximally extending appendages 222, 224 may be configured to receive at least a portion of the tuning shaft (not shown) received by the first opening 206. The inner surfaces 218, 220 of the proximally extending appendages 222, 224 may be contiguous with the inner channel 214 extending from the first opening 206 to the second opening 210.

FIG. 8A is a top view of the adapter 200 of FIG. 2 showing the second opening 210. FIG. 8B is a top view of the adapter of FIG. 2 showing the overlap of the distal end 208 to the proximal end 204. As shown in FIGS. 7A-B and 8A-B, the cross-sectional area of the first opening 206 (bolded dotted lines in FIG. 8B) may differ from the cross-sectional area of the second opening 210. In other words, the first opening 206 may have different dimensions (e.g., length and width respective to the longitudinal axis LT) than the second opening 210.

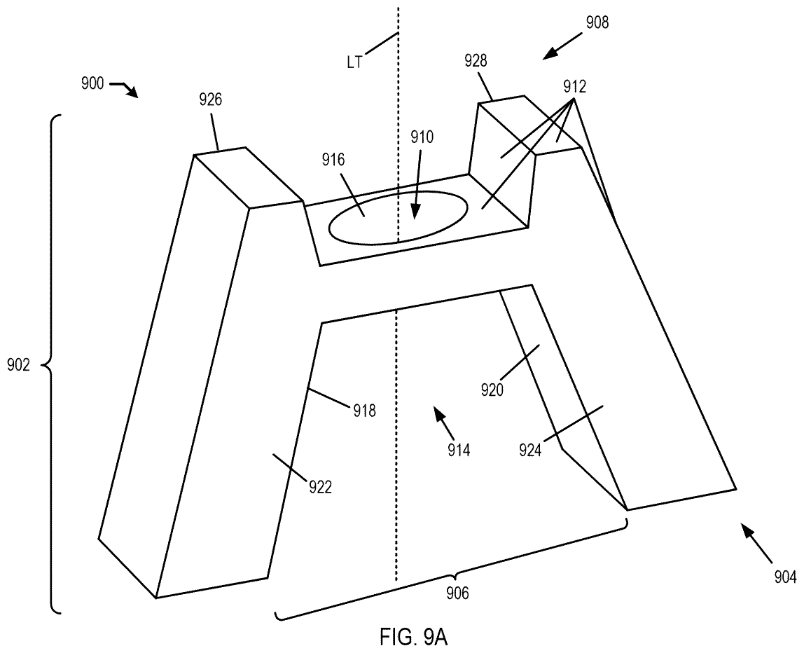

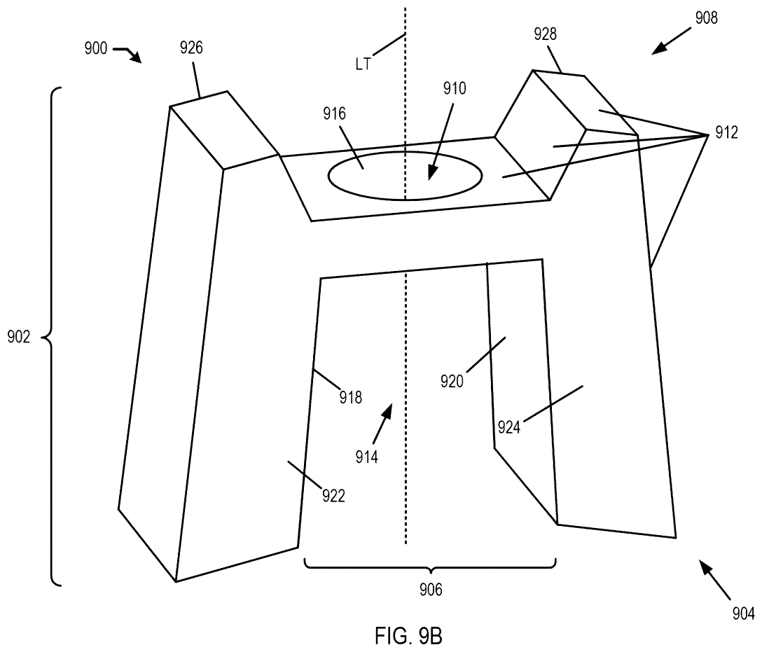

FIG. 9A is a front perspective view of an “M-shaped” adapter 900, according to one embodiment of the present disclosure. FIG. 9A illustrates the “M-shaped” adapter 900 without attachment to a tuning shaft, fastener, or tuning head, for clarity. The “M-shaped” adapter 900 may include all of or part of the features described of adapter 200 of FIGS. 2-8B. For example, the adapter 900 includes a body 902 extending along a longitudinal axis LT. The longitudinal axis LT may be imaginary (or a conceptual line) or may correspond to a physical component of the adapter 900. The body 902 includes a proximal end 904 including a first gap or opening 906 configured to receive the tuning shaft (not shown). The body 902 further includes a coupling surface 912 configured to removably engage a complementary surface (not shown) of a tuning head (not shown). The body 902 further includes a second opening 910 configured to receive a fastener (not shown) for coupling the adapter 900 to the tuning shaft (not shown). The second opening 910 may be disposed on or at the distal end 908 or on a portion of the body 902 between the proximal end 904 and the distal end 908.

The body 902 of the adapter 900 may further include an inner channel 914 defined (or bound) by inner surfaces 916, 918, 920 extending from the first opening 906 to the second opening 910. The inner channel 914 may be a channel, void, or volume of any size or shape. For example, the inner channel 914 may have varying cross-sectional dimensions (e.g., diameter, length, and/or width) along the entire length (or height respective to the longitudinal axis LT) of the inner channel 914. For example, the inner channel 914 may have a funnel shape, which increases in diameter in one direction (e.g., the first opening 906 may have a larger diameter or area than the second opening 910). The inner channel 914 may have an interior contour that matches the geometry of the tuning shaft (not shown) in order to fit varied shapes and size of the tuning shaft.

The inner surfaces 916, 918, 920 that define the inner channel 914 may include additional reinforcement mechanisms, such as specific topography, to further stabilize the coupling between the adapter 900 and the tuning shaft. For example, the addition reinforcement mechanisms (or specific topography) may include reinforcing ribs, webs, gussets, bars, mesh, wires, inserts, bushings, threads, varying wall thickness (or contour), material selection and composition, coatings, plating, interlocking (or sandwich) structures, or the like.

The adapter 900 may further include proximally extending appendages 922, 924 (e.g., at least two proximally extending appendages 922, 924). In the example shown in FIG. 9, these appendages 922, 924 extend away from the distal end 908 of the body 902 of the adapter 900 in a proximal direction. Portions of the appendages 922, 924 may also extend away from the longitudinal axis LT (e.g., in a direction transverse or perpendicular to the longitudinal axis LT). The adapter 900 may include any number of proximally extending appendages 922, 924. The proximally extending appendages 922, 924 may be any shape or size. For example, as illustrated in FIG. 9A, the proximally extending appendages 922, 924 may be rectangular, trapezoidal, or a parallelogram-shaped. Further, the proximally extending appendages 922, 924 may be equiangular, equilateral, rounded, cylindrical, or the like. The proximally extending appendages 922, 924 may include inner surfaces 918, 920 (or a respective inner surface 918, 920). The inner surfaces 918, 920 of the proximally extending appendages 922, 924 may be any shape, size, or contour. For example, as illustrated in FIG. 9A, the inner surfaces 918, 920 of the proximally extending appendages 222, 224 may be rectangular and flat. In another example, the inner surfaces 918, 920 of the proximally extending appendages 222, 224 may be rounded. In another embodiment, a respective inner surface 918, 920 of a respective proximally extending appendage 918, 920 may be one or more surfaces, where each of the one or more surfaces may have the same or different contour from another one of the one or more surfaces.

The first opening 906 and the second opening 910 may be concentric (or concentric with the longitudinal axis LT). For example, the first opening 906 and the second opening 910 may share a common central axis (e.g., longitudinal axis LT). However, the first opening 906 and the second opening 910 are not limited to the aforementioned configuration. For example, the first opening 906 and the second opening 910 may be displaced from each other at different distances (e.g., length and/or width) from the central axis (e.g., longitudinal axis LT). In other words, the first opening 906 may be displaced at a respective distance (e.g., length and/or width) from the central axis (e.g., longitudinal axis LT) that is different from the second opening 910.

The body 902 may include one or more distally extending appendages 926, 928 (e.g., at least one distally extending appendage). As illustrated in FIG. 9A, the body 902 includes two distally extending appendages 926, 928. The one or more distally extending appendages 926, 928 may be any shape or size. For example, the distally extending appendages 926, 928 may be rectangular, trapezoidal, cylindrical, rounded, or the like.

The distal end 908 of the body 902 may further include a portion of the coupling surface 912. For example, the coupling surface 912 may be one or more surfaces of the body 902. As illustrated in FIG. 9A, a first portion of the coupling surface 912 may be the distal end 908 of the body 902 including the second opening 910. A second portion of the coupling surface 912 may be the distal outer portion of the distal end 908 of the body 902. As illustrated in FIG. 9A, a third portion, a fourth portion, and a fifth portion of the coupling surface 912 may be the distal inner portion, the distal top portion, and/or the distal outer portion of the one or more distally extending appendages 926, 928, respectively. A sixth portion of the coupling surface 912 may be the distal outer portion of one or more of the proximally extending appendages 922, 924. The coupling surface 912 of “M-shaped” adapter 900 may allow for “plug-and-play” capabilities of the tuning head (not shown). The adapter 900 may reduce the form factor of the tuning head, allowing for a slimmer tuning head. The adapter 900 may be more easily manufactured, thus improving overall product efficiency.

Both the “M-shaped” adapter 900 of FIG. 9A and the adapter 200 of FIGS. 2-8B may be a “clasp” or compliant mechanism having at least two side portions (i.e., proximally extending appendages 222, 224, 922, 924) with a middle portion therebetween. Each of the adapters may also include an inner channel 214, 914 (e.g., a gap, void, or cavity) configured to receive a tuning peg and screw. In each example, the middle portion includes a hole configured to accommodate a screw. Once the adapter is placed over a tuning peg shaft, a screw is able to be inserted through the hole of the middle portion and then into the tuning peg shaft threaded hole. As the screw is tightened, force is applied onto features of the top part of the adapter (i.e., the compliant mechanism or clasp adapter) which causes deflection of the bottom part of the adapter to create a clasping force between the adapter and the tuning peg shaft thereby locking the rotation of the adapter about the tuning peg shaft. In other words, as the screw is tightened, the screw head exerts outward forces (away from the screw head) on top parts of each side portion of the adapter (i.e., inside faces or surfaces of the top parts of each side portion), which in turn causes the bottom parts of each side portion to flex inward or deform, as shown in FIG. 9B (to the screw or peg shaft), thus grasping or gripping the tuning peg shaft and locking the adapter in place over the tuning peg shaft. The adapter or compliant mechanism in these examples have a certain contour which is then matched by the custom tuning head which also locks the rotation of the tuning head about the tuning peg shaft and allows for tuning of the tuning peg. This configuration also allows for plug and play capabilities of the customized tuning heads. In other words, regardless of the shape of the shaft, the disclosed compliant mechanism or adapter will at least grasp or grip two surfaces of the shaft.

FIG. 9B is a front perspective view of the “M-shaped” adapter 900 of FIG. 9A showing the deformation, or deflection, of the appendages 922, 924. FIG. 9B illustrates that the proximally extending appendages 922, 924 may deflect or deform upon certain forces exerted on the adapter 900, as discussed above. The distally extending appendages 926, 928 may also deflect or deform. The distally extending appendages 922, 924 may deflect or deform along with the distally extending appendages 926, 928 but are not limited thereto. For example, the proximally extending appendages 922, 924 may deflect or deform independently of each other. The distally extending appendages 926, 928 may also deflect or deform independently of each other. The proximally extending appendages 922, 924 may deflect or deform independently of the distally extending appendages 926, 928, and vice versa. In other words, the proximally extending appendages 922, 924 and/or the distally extending appendages 926, 928 may be elastically deformed. The proximally extending appendages 922, 924 and/or the distally extending appendages 926, 928 may be elastically deformed such that the size (e.g., length and/or width) of the first opening 906 and/or the second opening 910 decreases.

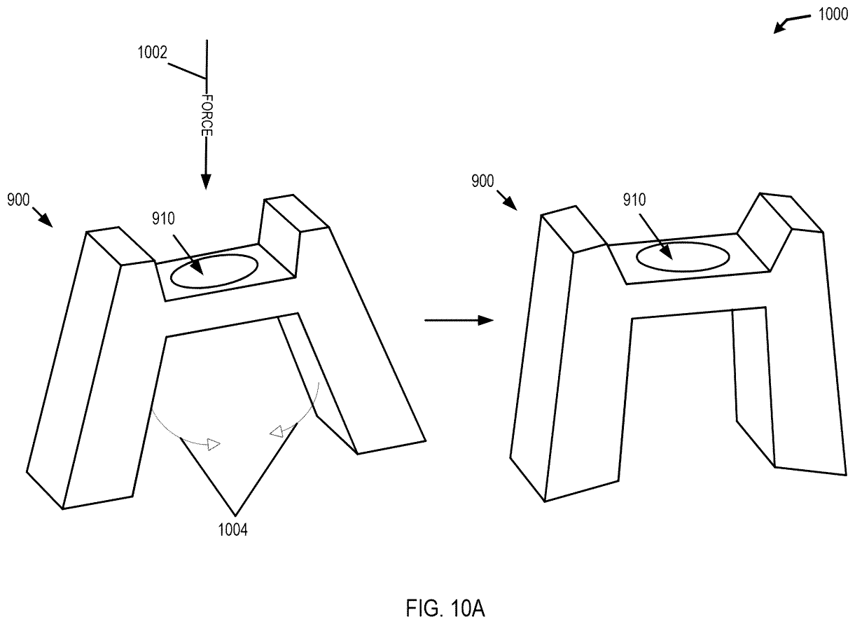

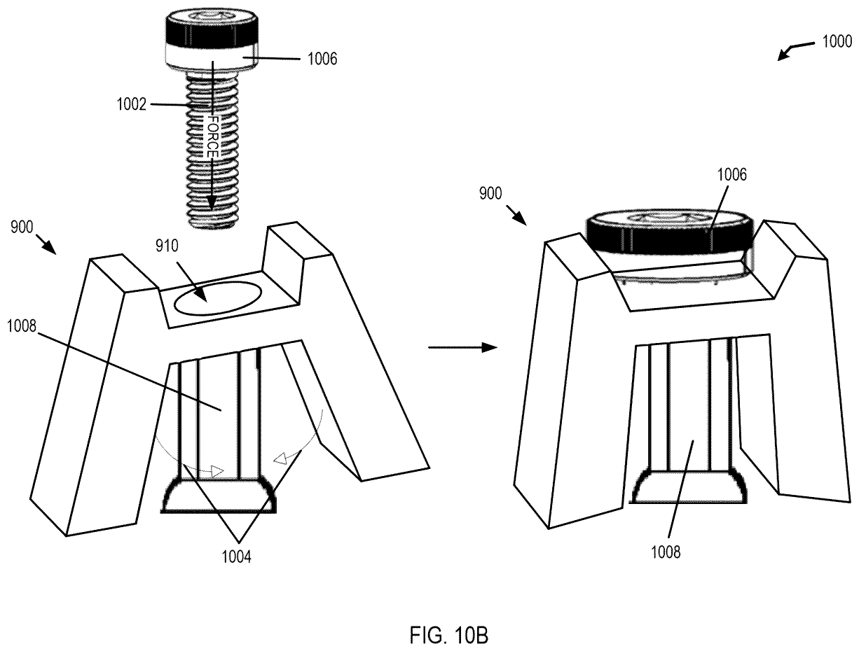

FIG. 10A illustrates the two states of the “M-shaped” adapter 900 of FIG. 9A responsive to a downward force 1002, according to one embodiment of the present disclosure. The features illustrated and described in FIG. 10A may also apply to the adapter 200 of FIG. 2. FIG. 10A illustrates a downward force 1002 (or a proximally applied force 1002) on the distal end 908 of the body 902 of the “M-shaped” adapter 900. For example, the proximally applied force 1002 may be any substantially downward force respective to the longitudinal axis LT. The proximally extending appendages 922, 924 may be configured to deflect in response to the proximally applied force 1002 at the distal end 908 of the body 902. The proximally extending appendages 922, 924 may be configured to generate a force 1004 (or clamping force 1004) between the two proximally extending appendages 922, 924. For example, the proximally extending appendages 922, 924 may be configured to generate a clamping force 1004 between the proximally extending appendages 922, 924 and the tuning shaft (not shown). In other words, in response to the proximally applied force 1002, the proximally extending appendages 922, 924 may generate a clamping force 1004 on the tuning shaft. A magnitude of the clamping force 1004 may be directly proportional to a magnitude of the proximally applied force 1002. Thus, the clamping force 1004 generated is based on the proximally applied force 1002.

The proximally applied force 1002 may induce an elastic deformation of the proximally extending appendages 922, 924 and also the distally extending appendages 926, 928. The elastic deformation may correspond substantially to the clamping force 1004. For example, the elastic deformation may be directly proportional to the clamping force 1004. The elastic deformation may decrease the size of the first opening 906. The elastic deformation may apply the clamping force 1004 to the tuning shaft.

FIG. 10B illustrates the two states of the “M-shaped” adapter of FIG. 9A responsive to an axial translation of a fastener 1006, according to one embodiment of the present disclosure. The axial translation of the fastener 1006 received by the second opening 910 may induce an elastic deformation of the proximally extending appendages 922, 924 and/or the distally extending appendages 926, 928. In other words, the fastener 1006 may be configured to be axially translated along the longitudinal axis LT (or substantially downward respective to the longitudinal axis LT) to induce an elastic deformation of the proximally extending appendages 922, 924 and/or distally extending appendages 926, 928. The induced elastic deformation may decrease the size of the first opening 906 and/or the second opening 910. For example, the induced elastic deformation may include an inward flexion of the proximal ends of the proximally extending appendages 922, 924 and/or outward flexion of the distal ends of the distally extending appendages 926, 928. The induced elastic deformation may apply a clamping force 1004 to a tuning shaft 1008. The clamping force 1004 to the tuning shaft 1008 may lock the rotation of the adapter 900 about the tuning shaft 1008. In other words, as with the adapter 200, the adapter 900 may use the material properties of the adapter 900 to couple the adapter 900 to the tuning shaft 1008, with or without the fastener 1006 (as in FIG. 10A). For example, regardless of the shape of the tuning shaft 1008, the adapter 900 may grasp or grip at least two surfaces of the tuning shaft 1008. The magnitude of the clamping force 1004 may be directly proportional to the degree of axial translation of the fastener 1006.

The fastener 1006 may be configured to exert outward forces, such as forces lateral to the fastener 1006, on one or more of the inner surfaces 916, 918, 920 of the body 902 of the adapter 900 during the axial translation. For example, the axial translation may cause the fastener 1006 to exert outward forces on the inner surfaces of the distally extending appendages 926, 928, elastically deforming the distally extending appendages 926, 928 (e.g., outward flexion), which in turn may cause the proximally extending appendages 922, 924 to elastically deform (e.g., inward flexion), thus grasping or gripping the tuning shaft 1008 and locking the adapter 900 in place over the tuning shaft 1008. In other words, as shown on the right image of FIG. 10B, the head (i.e., top or distal end) of the fastener 1006 may contact and exert outward forces on the inner surfaces of the distally extending appendages 926, 928 as the fastener 1006 is tightened (in the downward or proximal direction), which causes the proximally extending appendages 922, 924 to elastically deform inward, thus grasping or gripping the tuning shaft 1008 and locking the adapter 900 in place over the tuning shaft 1008. The proximally extending appendages 222, 224 of adapter 200 of FIG. 2 may exhibit a similar mechanism of inward flexion despite the adapter 200 lacking distally extending appendages. The features illustrated and described in FIG. 10B may also apply to the adapter 200 of FIG. 2.

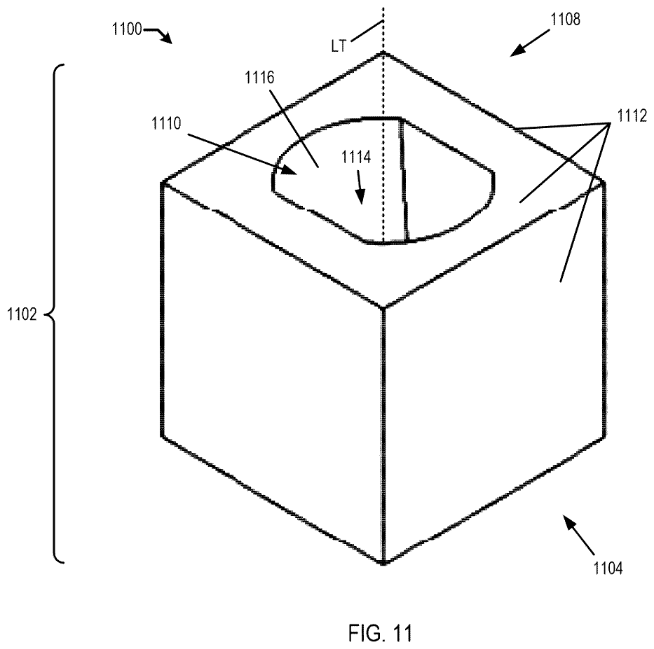

FIG. 11 is a perspective view of a “prism-shaped” adapter 1100 for a d-shaft tuning peg (not shown), according to one embodiment of the present disclosure. FIG. 11 illustrates the “prism-shaped” adapter 1100 without attachment to a tuning shaft, fastener, or tuning head, for clarity. The “prism-shaped” adapter 1100 may include all of or part of the features described of adapter 200 of FIGS. 2-8B and/or the “M-shaped” adapter 900 of FIGS. 9A-10B. For example, the adapter 1100 includes a body 1102 extending along a longitudinal axis LT. The longitudinal axis LT may be imaginary (or a conceptual line) or may correspond to a physical component of the adapter 1100. The body 1102 includes a proximal end 1104 including a first opening 1106 configured to receive the tuning shaft (not shown). The body 1102 further includes a coupling surface 1112 configured to removably engage a complementary surface (not shown) of a tuning head (not shown). The body 1102 further includes a second opening 1110 configured to receive a fastener (not shown) for coupling the adapter 1100 to the tuning shaft (not shown). The second opening 1110 may be disposed on or at the distal end 1108 or on a portion of the body 1102 between the proximal end 1104 and the distal end 1108.

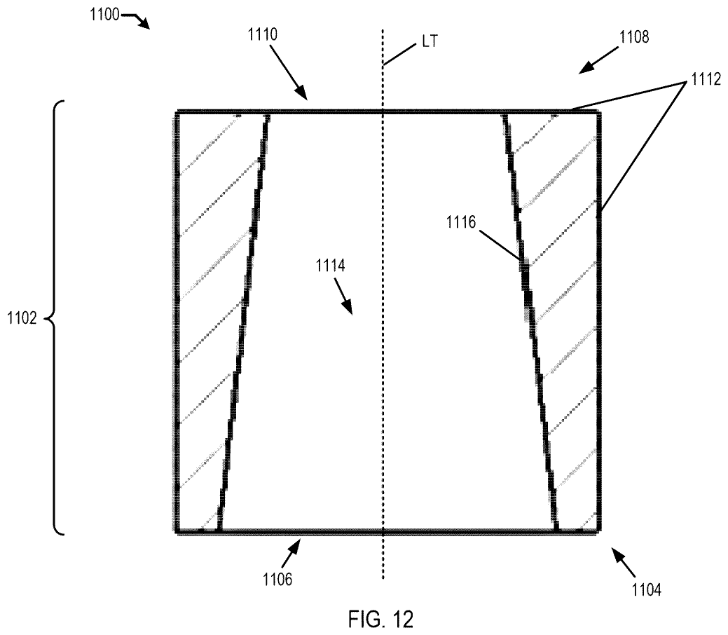

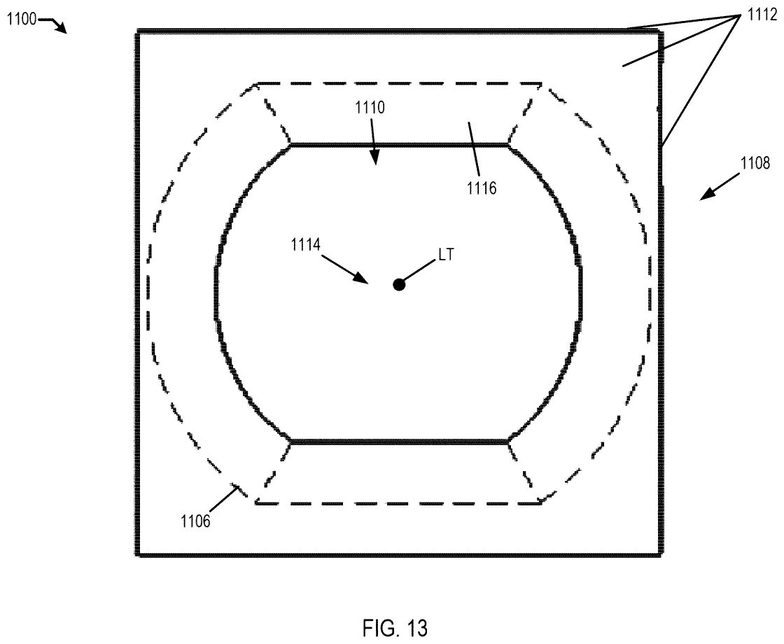

FIG. 12 is a cross-sectional view of the “prism-shaped” adapter 1100 of FIG. 11 showing the inside contour, such as an inner surface 1116. As illustrated in FIG. 12, the body 1102 of the adapter 1100 may further include an inner channel 1114 defined (or bound) by the inner surface 1116 extending from the first opening 1106 to the second opening 1110. The inner channel 1114 may be a channel of any size or shape. For example, the inner channel 1114 may have varying cross-sectional dimensions (e.g., diameter, length, and/or width) along the entire length (or height respective to the longitudinal axis LT) of the inner channel 1114. Referring back to FIG. 11, the inner channel 1114 may, as illustrated, correspond to a shape of the tuning shaft (not shown), such as a d-shaft tuning peg (not shown). The inner channel 1114 may have an interior contour that matches the geometry of the tuning shaft in order to fit varied shapes and size of the tuning shaft. In other words, the inner channel 1114 may include a shape following a double D-shaft contour, as shown further in FIG. 13. For example, the inner channel 1114 may have a funnel shape, which increases in diameter in one direction (e.g., the first opening 1106 may have a larger diameter than the second opening 1110).

The inner surface 1116 of the body 1102 may be any shape, size, or contour. The inner surface 1116 may be one or more surfaces, where each of the one or more surfaces may have the same or different contour from another one of the one or more surfaces. The inner surface 1116 that defines the inner channel 1114 may include additional reinforcement mechanisms, such as specific topography, to further stabilize the coupling between the adapter 1100 and the tuning shaft (not shown). For example, the addition reinforcement mechanisms (or specific topography) may include reinforcing ribs, webs, gussets, bars, mesh, wires, inserts, bushings, threads, varying wall thickness (or contour), material selection and composition, coatings, plating, interlocking (or sandwich) structures, or the like.

The first opening 1106 and the second opening 1110 may be concentric (or concentric with the longitudinal axis LT). For example, the first opening 1106 and the second opening 1110 may share a common central axis (e.g., longitudinal axis LT). However, the first opening 1106 and the second opening 910 are not limited to the aforementioned configuration. For example, the first opening 1106 and the second opening 1110 may be displaced from each other at different distances (e.g., length and/or width) from the central axis (e.g., longitudinal axis LT). In other words, the first opening 1106 may be displaced at a respective distance (e.g., length and/or width) from the central axis (e.g., longitudinal axis LT) that is different from the second opening 1110.

The body 1102 may further include the coupling surface 1112. For example, the coupling surface 1112 may be one or more surfaces of the body 1102. As illustrated in FIGS. 11-13, a first portion of the coupling surface 1112 may be the distal end 1108 of the body 1102 including the second opening 1110. A second portion of the coupling surface 1112 may be the distal outer portion of the distal end 1108 of the body 1102, such as the distal portions of the outer side walls of the body 1102. The coupling surface 1112 of adapter 1100 may allow for “plug-and-play” capabilities of the tuning head (not shown). The adapter 1100 may reduce the form factor of the tuning head, allowing for a slimmer tuning head. The adapter 1100 may be more easily manufactured, thus improving overall product efficiency.

FIG. 13 is a top view of the “prism-shaped” adapter 1100 of FIG. 11 showing a double D-shaft contour, where the first opening 1106 (outermost circumferential dotted line of FIG. 13) is larger than the second opening 1110. As discussed above, the contour, shape, and/or size of the first opening 1106 and the second opening 1110 may correspond to one another. The contour, shape, and/or size of the first opening 1106 and the second opening 1110 may correspond to the contour, shape, and/or size of the tuning shaft (not shown) received at the first opening 1106, such that the adapter 1100 fits over top of the tuning shaft. For example, for a D-shaft tuning peg (not shown), the contour, shape, and/or size of the first opening and/or the second opening 1110 may be a “double-D” configuration.

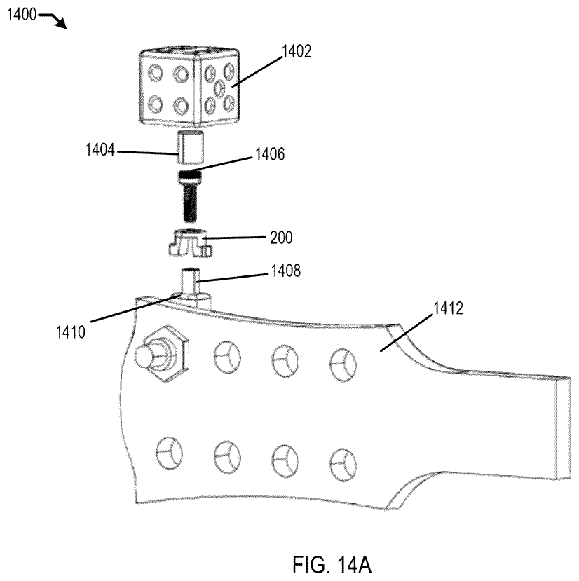

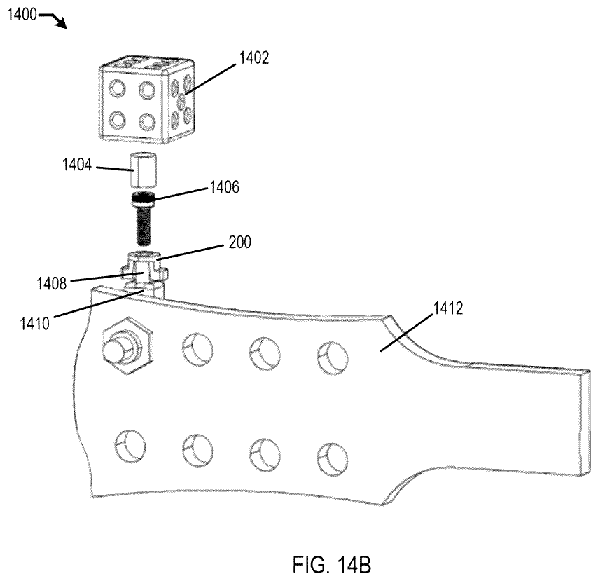

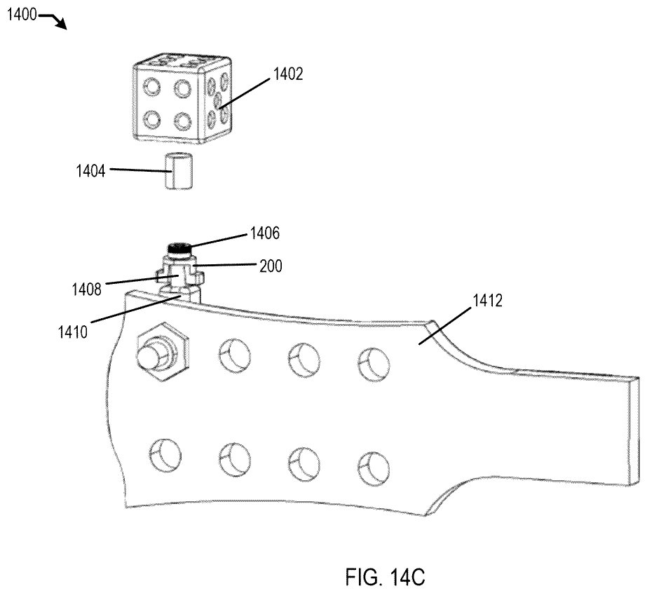

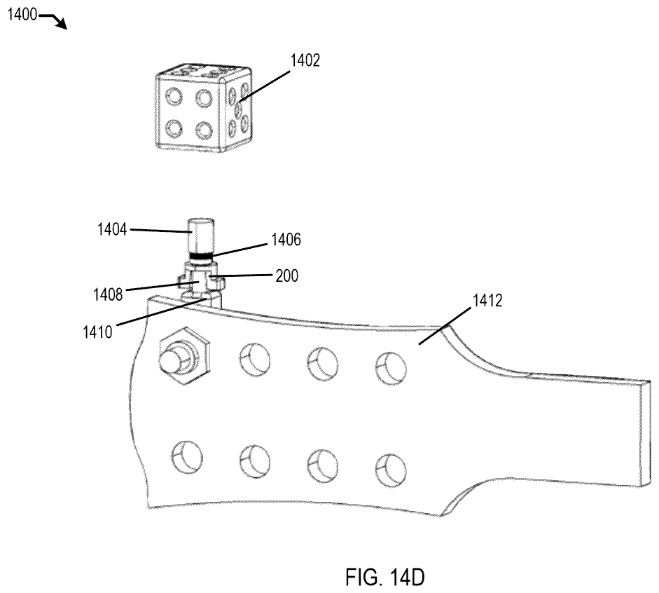

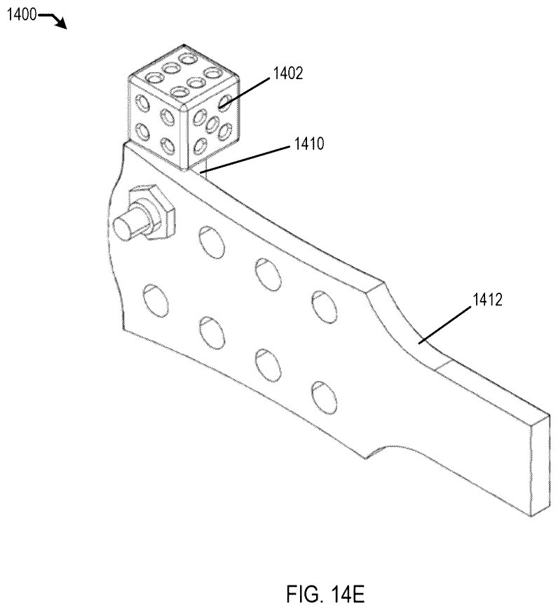

FIGS. 14A-E illustrate an exploded perspective view of the installation process of a tuning head adapter assembly 1400. FIG. 14A is an exploded perspective view of the tuning head adapter assembly 1400, including the adapter 200 of FIG. 2, a custom tuning head 1402, a tuning mechanism 1410, a tuning peg or shaft 1408, a fastener 1406, a magnet 1404, and a headstock 1412 of a stringed instrument (not shown), according to one embodiment of the present disclosure. The tuning head adapter assembly 1400 includes the tuning head 1402 (or the custom tuning head 1402), which includes the magnet 1404, and the adapter 200 of FIG. 2 configured to removably engage with the tuning head 1402.

FIG. 14B is an exploded perspective view of the tuning head adapter assembly 1400 of FIG. 14A showing the adapter 200 of FIG. 2 disposed on the tuning shaft 1408 of the tuning mechanism 1410. The tuning shaft 1408 may be inserted through, or disposed between, the first opening 206 of the adapter 200 of FIG. 2. In this way, the tuning shaft 1408 is received within the first opening 206 of the adapter 200.

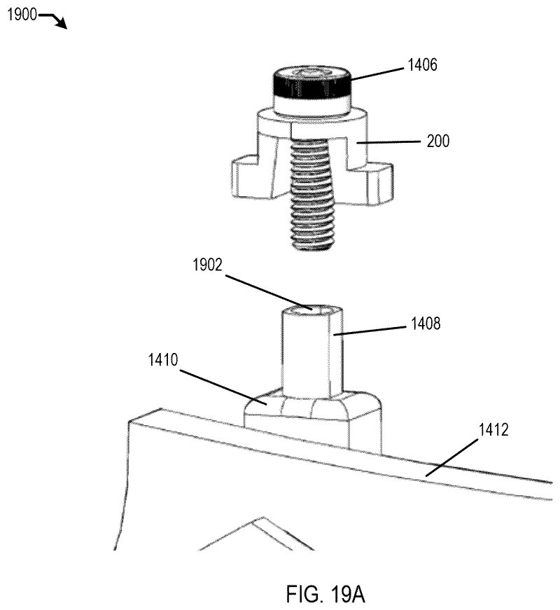

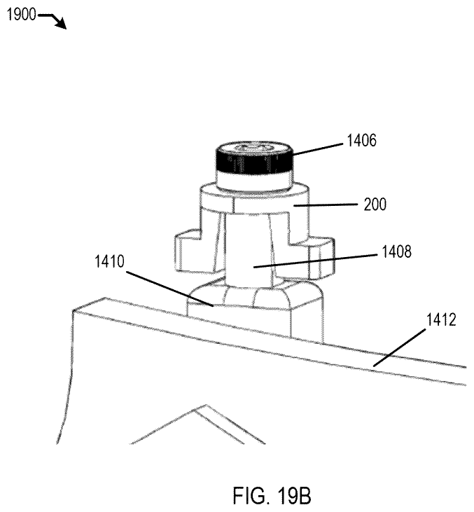

FIG. 14C is an exploded perspective view of the tuning head adapter assembly 1400 of FIG. 14A showing the fastener 1406 inserted into the second opening 210 of the adapter 200 and into the tuning shaft 1408, thereby securing or coupling the adapter 200 to the tuning shaft 1408, and thus the tuning mechanism 1410. For example, the second opening 210 of the adapter 200 may receive the fastener 1406 and may couple the adapter 200 to the tuning shaft 1408. The fastener 1406 may be inserted into an aperture 1902 of the tuning shaft 1408, as shown and described below in FIG. 19A-B. In other words, the aperture 1902 of the tuning shaft 1408 may receive the fastener 1406. The aperture 1902 of the tuning shaft 1408 may be a threaded hole.

FIG. 19A is an exploded perspective view of a tuning head adapter assembly 1900 showing the fastener 1406 disposed within the adapter 200 of FIG. 2, according to one embodiment of the present disclosure. For clarity, FIG. 19A illustrates the tuning head adapter assembly 1900 that is similar to the tuning head adapter assembly 1400 of FIGS. 14A-E but does not include the magnet 1404 or the tuning head 1402, for clarity of describing the coupling between the adapter 200, fastener 1406, and tuning shaft 1408. The fastener 1406 may be disposed, or received, within the adapter 200.

FIG. 19B is perspective view of the tuning head adapter assembly 1900 of FIG. 19A showing the adapter 200 coupled to the tuning shaft 1408 using the fastener 1406. The fastener 1406 may be any fastening or coupling means. For example, the fastener 1406 may be a threaded fastener, such as a screw. The fastener 1406 may be a bolt, screw, nail, nut, washer, drive, any combination thereof, or the like. The tuning shaft 1408 may engage a worm gear (not shown) and/or pinion gear (not shown) of the tuning mechanism 1410 (e.g., within the tuning mechanism 1410). For example, the tuning shaft 1408 may be configured to engage a worm gear (not shown) and/or pinion gear (not shown) of the tuning mechanism 1410 (e.g., within the tuning mechanism 1410), such that when the adapter 200 is coupled to the tuning shaft 1408 by the fastener 1406, rotating the adapter 200 causes the tuning shaft 1408 to rotate, thereby adjusting a string tension of the stringed instrument (not shown) to a desired frequency.

Referring now to FIG. 14D, FIG. 14D is an exploded perspective view of the tuning head adapter assembly 1400 of FIG. 14A showing the magnet 1404 disposed on the fastener 1406. The magnet 1404 may be magnetically coupled to the fastener 1406, thereby magnetically coupling the tuning head 1402 to the adapter 200, as described below in FIG. 14E. Using the magnetic coupling, the tuning head 1402 may be configured to connect and remain attached to the tuning shaft 1408 and the adapter 200. While the magnet 1404 is shown in FIG. 14D as a separate component, this is shown for ease of explanation and clarity. The magnet 1404 may be embedded in the tuning head 1402, such as in the upper or distal end (i.e., the end furthest away from fastener 1406) of the tuning head 1402, as described more fully below. In other words, the upper or distal end of the tuning head 1402 may include the magnet 1404 and the lower or proximal end of the tuning head 1402 may include the cavity into which the adapter 200 and fastener 1406 is received. Thus, when the tuning head 1402 is placed over the adapter 200 and fastener 1406, the magnet 1404 couples to the fastener 1406 as shown in FIG. 14D.

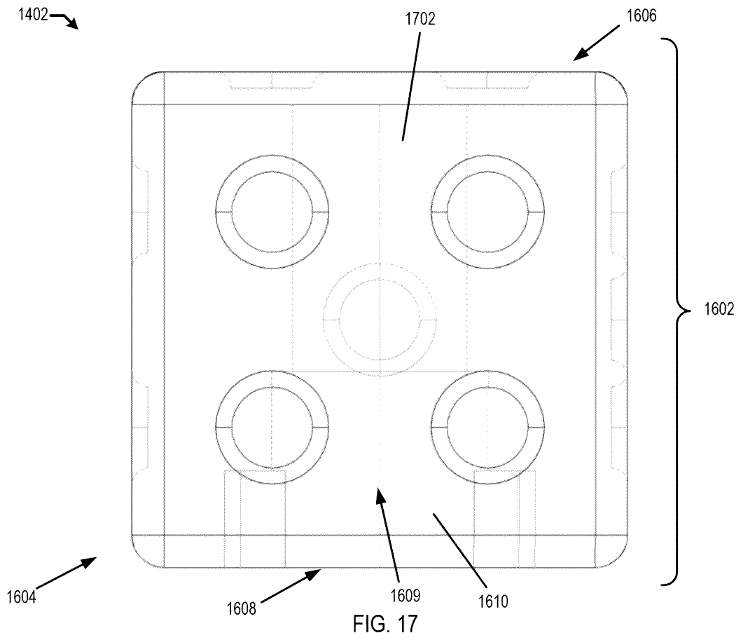

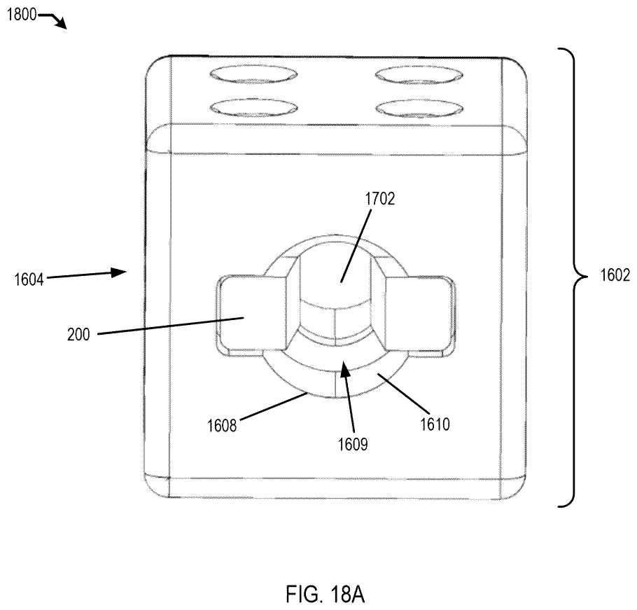

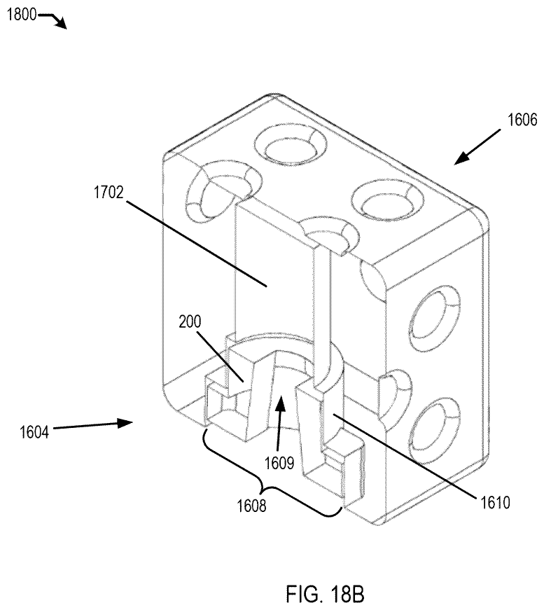

FIG. 14E is a perspective view of the tuning head adapter assembly 1400 of FIG. 14A showing the custom tuning head 1402 magnetically coupled to the adapter 200 of FIG. 2. The tuning head 1402 may be disposed over the fastener 1406, adapter 200, and the tuning shaft 1408. As shown and described below in FIGS. 17 and 18A-B, the magnet 1404 may be disposed within a housing of the tuning head 1402 in a magnet receiving portion 1702. In another embodiment, the tuning head 1402, the adapter 200, the fastener 1406, and/or the tuning shaft 1408 may be a magnet 1404 (or a magnetized material). In another embodiment, the tuning head 1402 may be coupled to the fastener 1406, adapter 200, the tuning shaft 1408, and/or the tuning mechanism 1410 without the use of the magnet 1404. For example, the tuning head 1402 may be removably coupled with the distal end 210 of the adapter 200 by at least one of snap-fit coupling, twist and lock coupling, plug and play coupling, clip-on coupling, screw-on coupling, hook and loop coupling, suction coupling, or friction coupling. In other words, the distal end of 210 of the adapter 200 may be removably coupled with the tuning head 1402 by at least one of magnetic coupling, snap-fit coupling, twist and lock coupling, plug and play coupling, clip-on coupling, screw-on coupling, hook and loop coupling, suction coupling, or friction coupling.

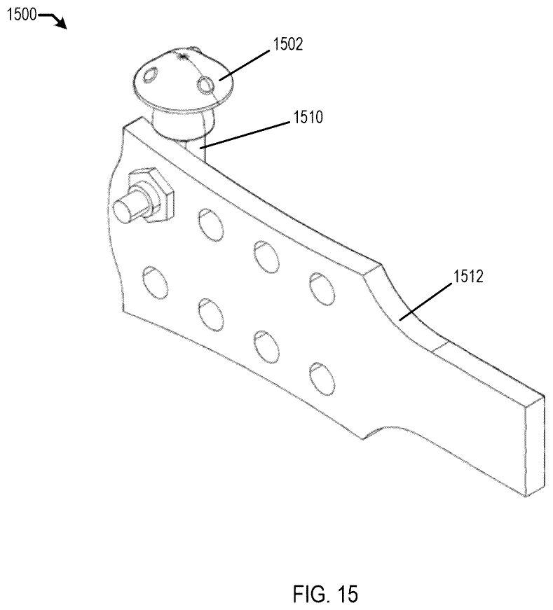

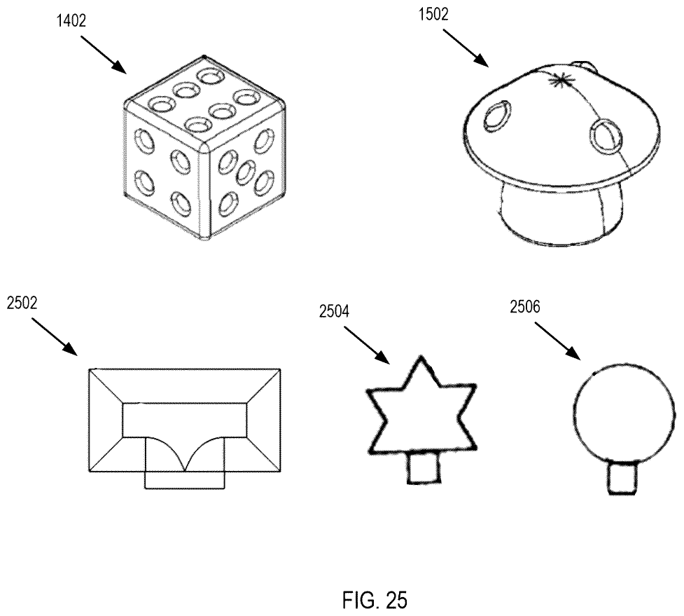

FIG. 15 is a perspective view of the tuning head adapter assembly 1400 of FIG. 14A with an alternate custom tuning head 1502, according to one embodiment of the present disclosure. The custom tuning head 1502 may be any shape or size. For example, as illustrated in FIG. 14A-E, the custom tuning head 1402 may be a “dice” shape. As illustrated in FIG. 15, the custom tuning head 1502 may be a “mushroom” shape. FIG. 25 shows various configurations and examples of different types of custom tuning heads 1402, 1502, 2502, 2504, 2506, according to multiple embodiments of the present disclosure. In addition to the “mushroom” and “dice” shape of the custom tuning heads 1402 and 1502, the custom tuning head 2502 may be rectangular with a unique topography (or topographical design). In another example, the custom tuning head 2504 may be a “star” shape. In yet another example, the custom tuning head 2506 may be circular or spherical. Each custom tuning head may be fully customizable with any topography (e.g., outer and/or inner), outer and/or inner geometry (e.g., outer and/or inner contour), visual design (e.g., outer and/or inner), or the like.

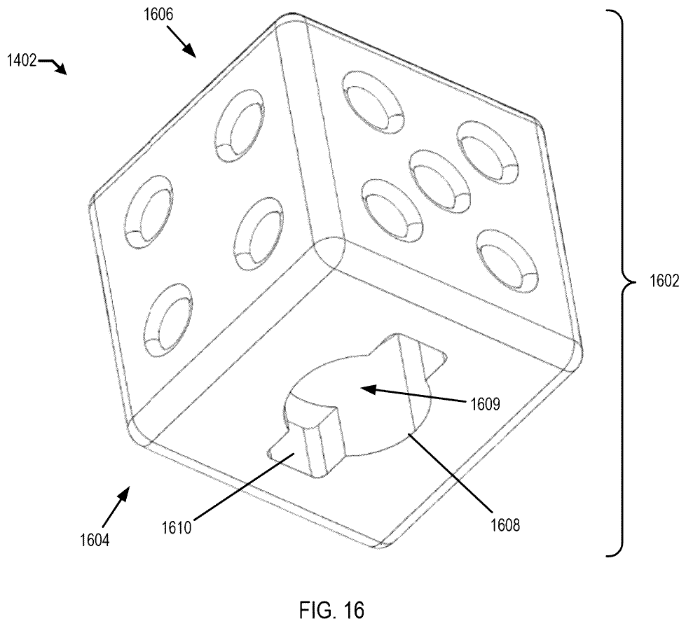

FIG. 16 is a bottom perspective view of the custom tuning head 1402 of FIG. 14A showing a receivable portion or an opening or aperture 1608, including a corresponding or complimentary surface 1610 of an inner cavity 1609 at a proximal end 1604 of the tuning head 1402. The custom tuning head 1402 may include a body 1602 including a proximal end 1604 and a distal end 1606. The proximal end 1604 of the tuning head 1402 includes the aperture 1608 and the cavity 1609 configured to receive an adapter, such as the adapter 200 of FIG. 2. The inside surface of the cavity 1609 of the tuning head 1402 may be a corresponding or complimentary surface 1610 to the adapter, such as the adapter 200 of FIG. 2, further shown and described below in FIGS. 17 and 18A-B. For example, the complementary surface 1610 may have a profile that is complementary to the outside geometry (e.g., shape, size, and/or contour) of the adapter, such as the adapter 200 of FIG. 2. In other words, the inside surface of the cavity 1609 of the tuning head 1402 may have matching features to the outside profile geometry (e.g., shape, size, and/or contour) of the adapter 200, such that the adapter 200 nests within the cavity 1609 of the tuning head 1402.

FIG. 17 is a side view of the custom tuning head 1402 of FIG. 14A showing the contour, or the shape, of the receivable portion 1608 and cavity 1609, including the complimentary surface 1610. For clarity, FIG. 17 illustrates the custom tuning head 1402 of FIG. 14A without an adapter or a magnet. The tuning head 1402 may include a magnet receiving portion 1702 within the body 1602 of the tuning head 1402. The magnet receiving portion 1702 may be disposed at a distal end 1606 of the tuning head 1402. The magnet receiving portion 1702 may have a profile that is complementary to the outside geometry (e.g., shape, size, or contour) of the magnet, such as the magnet 1404 of FIG. 14A. The magnet receiving portion 1402 may be configured to receive other components of the tuning head adapter assembly 1400, such as, but not limited to, the fastener 1406 and/or the tuning shaft 1408, or portions thereof. The magnet receiving portion 1402 may be configured to receive other components, such as a light, LED, display, indicator, motors, electronic components (e.g., electronic tuner, Bluetooth sensor, speaker, etc.), or the like. For example, the other components may be configured to automatically tune the stringed instrument, such as with the aid of the electronic components and motors (e.g., one or more motors). The other components may be configured to provide audio and/or visual feedback to the user for correcting tuning of the stringed instrument. The other components may be configured to provide audio and/or visual signal for purely cosmetic purposes. The other components may be configured to be modulated by an external software to provide a pre-programmed audio and/or visual sequence.

FIG. 18A is a bottom perspective view of the custom tuning head 1402 of FIG. 14A showing the adapter 200 of FIG. 2 disposed within the cavity 1609 of the tuning head 1402. FIG. 18B is a cross-section view of the configuration of FIG. 18A. As illustrated in both FIGS. 17 and 18A-B, the magnet receiving portion 1702 may be disposed above (or distal to) the receiving portion 1608, the cavity 1609, and the complementary surface 1610.

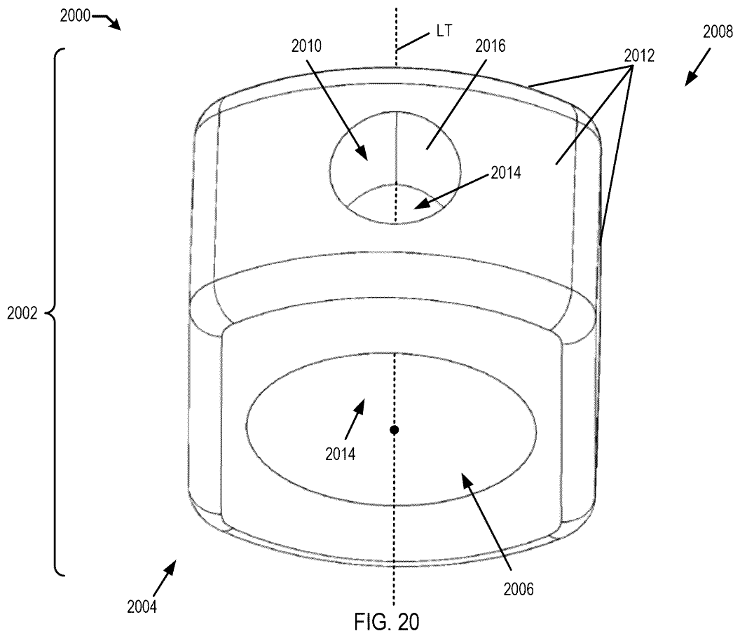

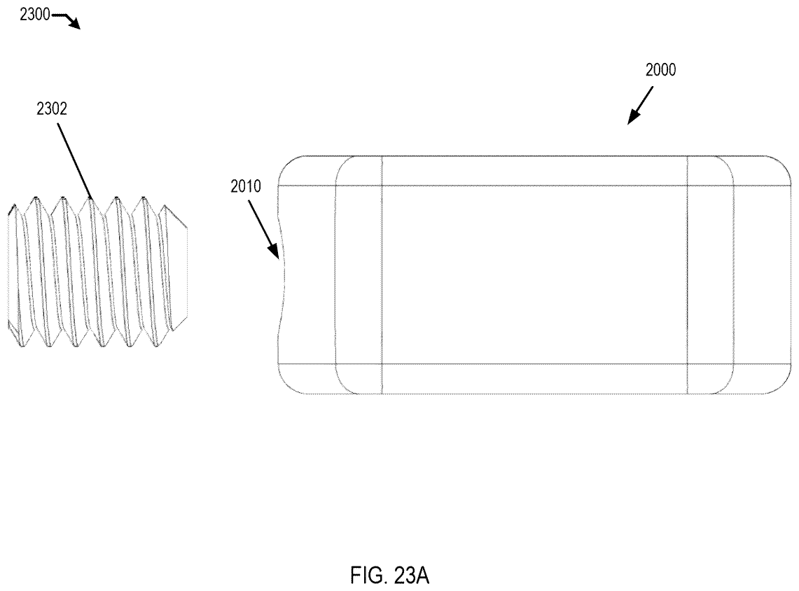

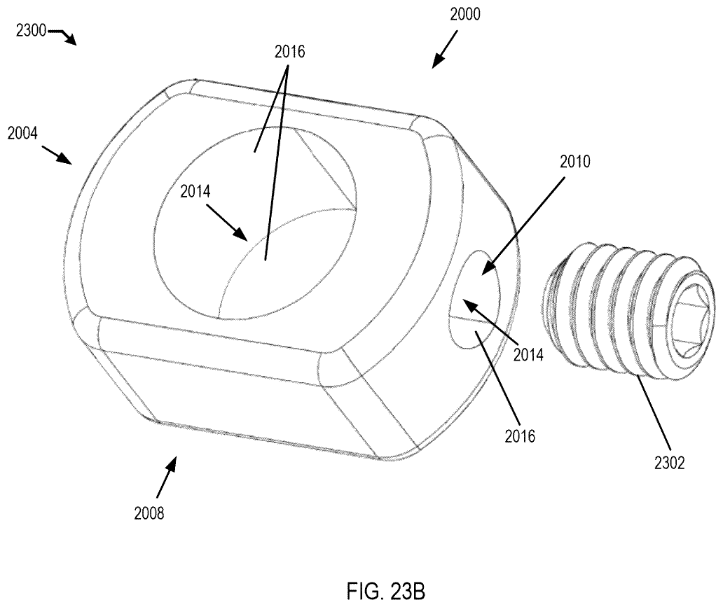

FIG. 20 is a side perspective view of a “side-hole” adapter 2000 for a tuning shaft (not shown) of a stringed instrument (not shown), according to one embodiment of the present disclosure. FIG. 20 illustrates the “side-hole” adapter 2000 without attachment to a tuning shaft, fastener, or tuning head, for clarity. The “side-hole” adapter 2000 may include all of or part of the features described above for the adapter 200 of FIGS. 2-8B, the “M-shaped” adapter 900 of FIGS. 9A-10B, and/or the “prism-shaped” adapter 1100 of FIGS. 11-13. For example, the adapter 2000 of FIG. 20 includes a body 2002 extending along a longitudinal axis LT. The longitudinal axis LT may be imaginary (or a conceptual line) or may correspond to a physical component of the adapter 2000. The body 2002 includes a proximal end 2004 including a first opening 2006 configured to receive the tuning shaft (not shown). The body 2002 further includes a distal end 2008 and an outer surface or coupling surface 2012 configured to removably engage a complementary surface (not shown) of a cavity of a tuning head (not shown). In other words, the shape of the body 2002 of the adapter 2000 and the shape of the cavity of the tuning head are complementary (i.e., they correspond to one another), such that the body 2002 of the adapter 2000 can fit within, or nest within, the cavity of the tuning head. The body 2002 also includes a cavity or an inner channel 2014 extending from the first opening 2006 at the proximal end 2004 into the body 2002 almost to the distal end 2008. In other words, the internal cavity or channel 2014 is sized and shaped to be able to receive or accommodate the tuning shaft within the cavity or channel 2014. In this way, the adapter 2000 fits over the tuning peg or shaft. The body 2002 further includes a second opening 2010, as also shown in FIG. 23A-B, configured to receive a fastener for coupling the adapter 2000 to the tuning shaft (not shown). The second opening 2010 may be disposed on a portion of the body 2002 between the proximal end 2004 and the distal end 2008, such as a sidewall of the body 2002 of the adapter 2000.

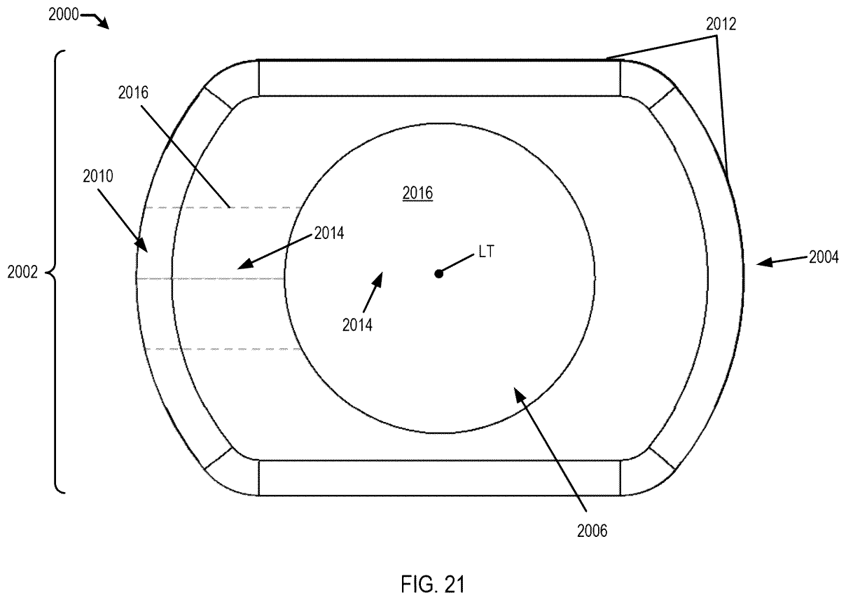

FIG. 21 is a bottom view of the “side-hole” adapter 2000 of FIG. 20 showing the inner cavity or channel 2014. As illustrated in FIG. 21, the body 2002 of the adapter 2000 may further include the inner cavity or channel 2014 defined (or bound) by an inner surface 2016 extending from the first opening 2006 into the body 2002 almost to the distal end 2008, and to the second opening 2010. The inner cavity or channel 2014 shown in the figures is a cylindrical bore or channel, but the inner channel 2014 may be a channel of any size or shape. For example, the inner channel 2014 may have varying cross-sectional dimensions (e.g., diameter, length, and/or width) along the entire length (or height respective to the longitudinal axis LT) and/or the entire width (or width respective to the longitudinal axis LT) of the inner channel 2014. The inner channel 2014 may correspond or at least partly correspond to a shape of the tuning shaft (not shown). For example, the inner channel 2014 may have an interior contour that matches or at least partly matches the geometry of the tuning shaft in order to fit varied shapes and size of the tuning shaft. For example, the inner channel 2014 may have a cylindrical shape (e.g., beginning at the proximal end 2004) with a cylindrical stud extending transverse to the longitudinal axis LT (e.g., extending out of the body 2002 between the proximal end 2004 and the distal end 2008). The inner channel may increase in diameter in one direction (e.g., the first opening 2006 may have a larger diameter than the second opening 2010).

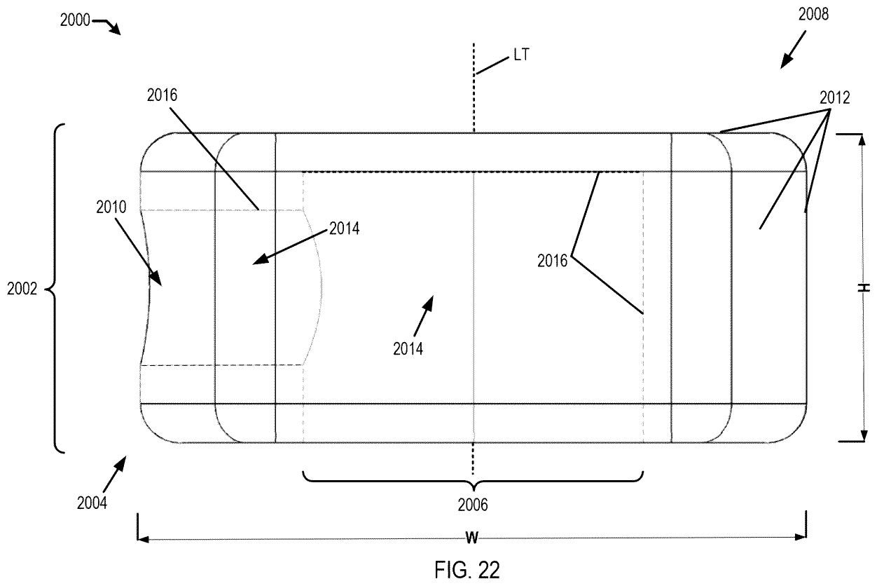

FIG. 22 is a front view of the “side-hole” adapter 2000 of FIG. 20 showing the internal configuration of the inner surface 2016 (internal dotted line of FIG. 22). The inner surface 2016 of the body 2002 may be any shape, size, or contour. The inner surface 2016 may be one or more surfaces, as illustrated in FIGS. 21, 22, and 23B, where each of the one or more surfaces may have the same or different contour from another one of the one or more surfaces. The inner surface 2016 that defines the inner channel 2014 may include additional reinforcement mechanisms, such as specific topography, to further stabilize the coupling between the adapter 2000 and the tuning shaft (not shown). For example, the addition reinforcement mechanisms (or specific topography) may include reinforcing ribs, webs, gussets, bars, mesh, wires, inserts, bushings, threads, varying wall thickness (or contour), material selection and composition, coatings, plating, interlocking (or sandwich) structures, or the like.

As mentioned above, the body 2002 may further include the coupling surface 2012. For example, the coupling surface 2012 may be one or more surfaces of the body 2002. As illustrated in FIGS. 20-22, a first portion of the coupling surface 2012 may be the distal end 2008 of the body 2002. A second portion of the coupling surface 2012 may be the distal outer portion of the distal end 2008 of the body 2002, such as the distal portions of the outer side walls of the body 2002 including the second opening 2010 (e.g., between the proximal end 2004 and the distal end 2008). The coupling surface 2012 of adapter 2000 may allow for “plug-and-play” capabilities of the tuning head. The adapter 2000 may reduce the form factor of the tuning head, allowing for a slimmer tuning head. The adapter 2000 may be more easily manufactured, thus improving overall product efficiency.

FIG. 22 further illustrates the adapter 2000 having a width W and a height H. The width W of the adapter 2000 is measured across the widest opposing external surfaces of the body 2002 of the adapter 2000, orthogonal to the longitudinal axis LT (e.g., orthogonal to the height H). The width W may be in a range from about 7.0 millimeters (mm) to 20.0 mm (e.g., about 7.0 mm to 16.0 mm, about 7.0 mm to 12.0 mm, about 7.0 mm to 10.00 mm, or the like). The width W may be any width greater than a width of a tuning shaft. The height H of the adapter is measured across the lowest-to-highest opposing external surfaces of the body 2002 of the adapter 2000, in line with the longitudinal axis LT (e.g., orthogonal to the width W), such as the overall height between the two most extreme opposing horizontal planes. In other words, the height H of the adapter is measured from a base plane (e.g., lowest point) to the highest point of the external surface of the body 2002. The height H may be in a range from about 3.0 mm to 7.0 mm (e.g., about 3.0 mm to 6.0 mm, about 3.0 mm to 5.0 mm, or the like). The height H may be any height equal to or less than a height of a tuning shaft. The height H may be greater than or less than the width W. For example, the height H may be approximately one-half the width W. The height H includes a first height H1 and a second height H2.

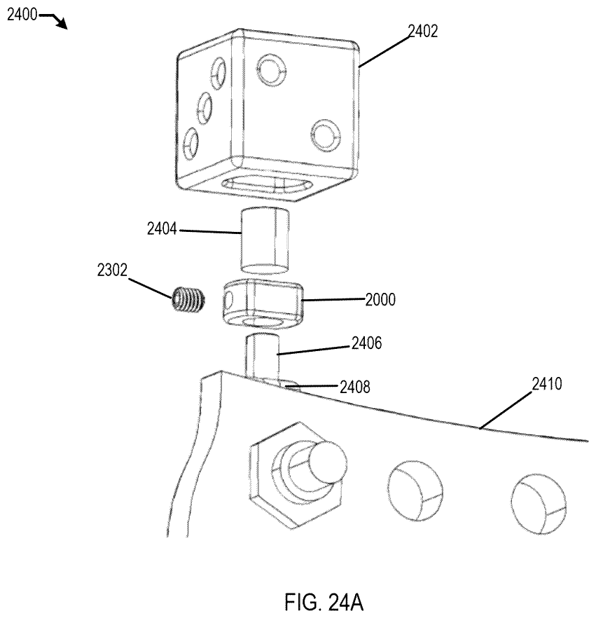

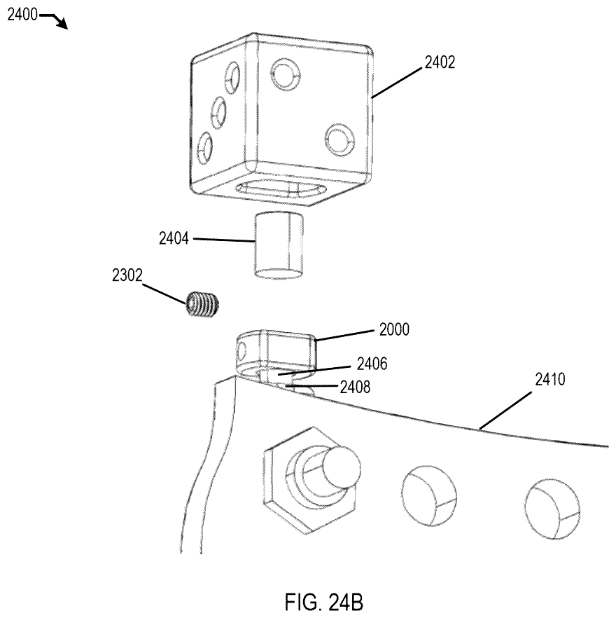

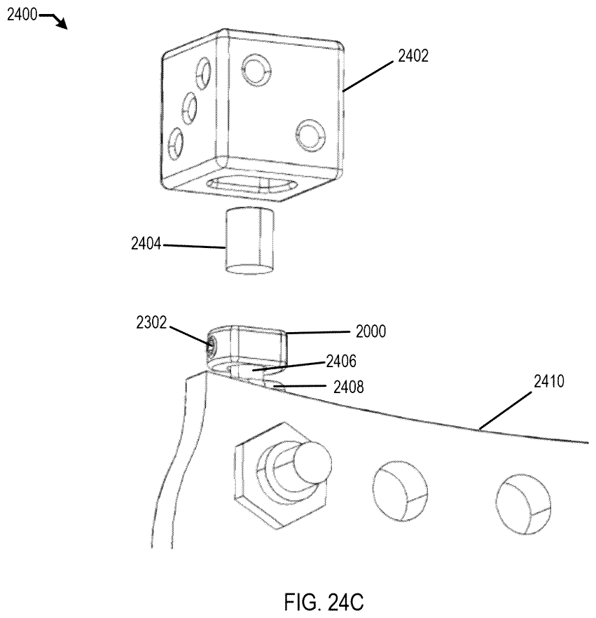

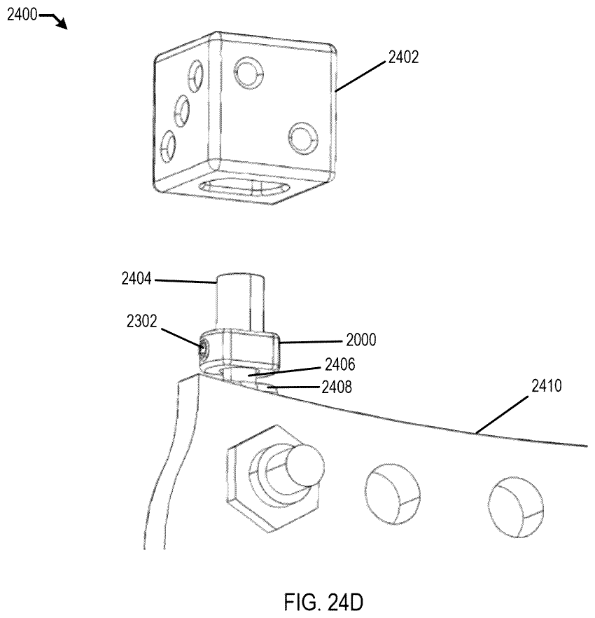

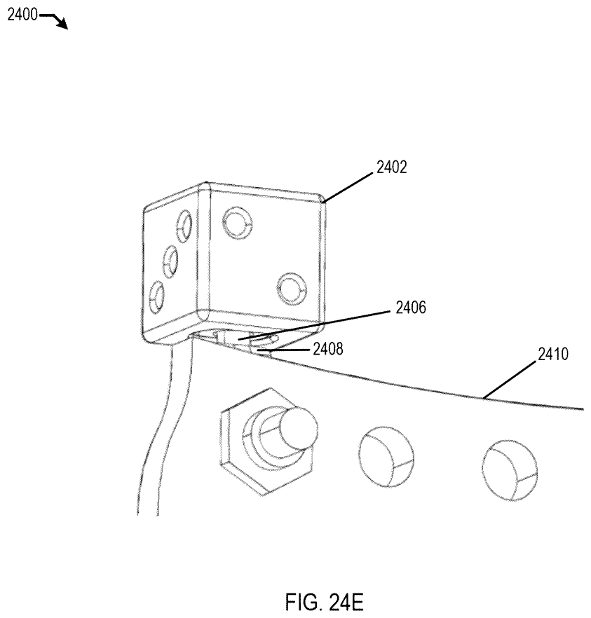

FIG. 23A is a side view of a fastener 2302 in relation to the “side-hole” adapter 2000 of FIG. 20, according to one embodiment of the present disclosure. FIG. 23B is a bottom perspective view of a fastener 2302 in relation to the “side-hole adapter of FIG. 20, showing the inner surface 2016 and the inner channel 2014 of the “side-hole” adapter 2000. The fastener 2302 may be any fastening or coupling means. For example, the fastener 2302 may be a threaded fastener, such as a set screw. The fastener 2302 may be a bolt, screw, nail, nut, washer, drive, any combination thereof, or the like. An axial translation of the fastener 2302 received by the second opening 2010 may couple the adapter 2000 to the tuning shaft 2406 (shown in FIGS. 24B-C). In other words, the adapter 2000 of FIG. 20 may be configured such that, when the fastener 2302 received by the second opening 2010 engages the tuning shaft 2406 (shown in FIGS. 24B-C), the adapter 2000 may be coupled to the tuning shaft 2406 (shown in FIGS. 24B-C), preventing rotation of the adapter 2000 relative to the tuning shaft 2406. For example, the adapter 2000 may use the fastener 2302 received by the second opening 2010 to clamp against the tuning shaft 2406, similar to a C-clamp, G-clamp, adjustable screw clamp, or the like. A portion of the fastener 2302 may engage the tuning shaft 2406, when received by the second opening 2010, thereby creating a clamping force between the portion of the fastener 2302 and the tuning shaft 2406, which fixes the adapter 2000 in place, preventing the adapter 2000 from rotating about the tuning shaft 2406.

FIGS. 24A-E illustrate an exploded perspective view of the installation process of a tuning head adapter assembly 2400. The tuning head adapter assembly 2400 of FIGS. 24A-E may include all of or part of the features described of the tuner head adapter assembly 1400 of FIGS. 14A-E. FIG. 24A is an exploded perspective view of a tuning head adapter assembly 2400, including the “side-hole” adapter 2000 of FIG. 20, a custom tuning head 2402, a tuning mechanism 2408, a tuning shaft 2406, a fastener 2302, a magnet 2404, and a headstock 2410 of a stringed instrument (not shown), according to one embodiment of the present disclosure. The tuning head adapter assembly 2400 includes the tuning head 2402 (or the custom tuning head 2402) and the adapter 2000 of FIG. 20 configured to removably engage with the tuning head 2402. While the figures show the magnet 2404 as a separate component, as discussed above the magnet 2404 is part of the tuning head 2402.

FIG. 24B is an exploded perspective view of the tuning head adapter assembly 2400 of FIG. 24A showing the “side-hole” adapter 2000 of FIG. 20 disposed on the tuning shaft 2406 of the tuning mechanism 2408. The tuning shaft 2406 may be inserted into, or disposed within, the first opening 2006 and inner channel 2014 of the adapter 2000 of FIG. 20.

FIG. 24C is an exploded perspective view of the tuning head adapter assembly 2400 of FIG. 24A showing the fastener 2302 inserted into the second opening 2010 of the “side-hole” adapter 2000 of FIG. 20, clamping the fastener 2302 onto the tuning shaft 2406, thereby securing the “side-hole” adapter 2000 to the tuning shaft 2406. For example, the second opening 2010 of the adapter 2000 may receive the fastener 2302 and may couple the adapter 2000 to the tuning shaft 2406.

FIG. 24D is an exploded perspective view of the tuning head adapter assembly 2400 of FIG. 24A showing the magnet 2404 disposed on the fastener 2302. The magnet 2404 may be magnetically coupled to the fastener 2302, thereby magnetically coupling the tuning head 2402 to the adapter 2000, as described below in FIG. 24E. Using the magnetic coupling, the tuning head 2402 may be configured to connect and remain attached to the tuning shaft 2406 and the adapter 2000. As mentioned above, while the magnet 2404 is shown separate and apart from the tuning head 2402 for clarity and ease of understanding, the magnet 2404 is embedded inside the tuning head 2402, such that when the adapter 2000 is received into the cavity or internal channel 2014 of the tuning head 2402, the magnet 2404 is in close proximity to the fastener 2302 to magnetically couple the tuning head 2402 to the adapter 2000. In another embodiment, the body 2002 of the adapter 2000, or at least a portion of the body 2002, is made from a material, such as metal, that allows the magnet to couple to that portion of the body 2002, thereby securing the tuning head 2402 to the adapter 2000.

FIG. 24E is a perspective view of the tuning head adapter assembly 2400 of FIG. 24A showing the custom tuning head 2402 magnetically coupled to the “side-hole” adapter 2000 of FIG. 20. The tuning head 2402 may be disposed over the fastener 2302, the adapter 2000, and at least a portion of the tuning shaft 2406 by way of the adapter 2000 nesting within the cavity or internal channel 2014 of the tuning head 2402. The same coupling may occur as with those described in FIGS. 17 and 18A-B. For example, the magnet 2404 may be disposed within a housing of the tuning head 2402 in a magnet receiving portion. In another embodiment, the tuning head 2402 may be coupled to the fastener 2302, adapter 2000, the tuning shaft 2406, and/or the tuning mechanism 2408 without the use of the magnet 2404. For example, the tuning head 2402 may be removably coupled with the distal end 2010 of the adapter 2000 by at least one of snap-fit coupling, twist and lock coupling, plug and play coupling, clip-on coupling, screw-on coupling, hook and loop coupling, suction coupling, or friction coupling. In other words, the distal end of 2010 of the adapter 2000 may be removably coupled with the tuning head 2402 by at least one of magnetic coupling, snap-fit coupling, twist and lock coupling, plug and play coupling, clip-on coupling, screw-on coupling, hook and loop coupling, suction coupling, or friction coupling.

As described herein, a universal or interchangeable tuning peg/shaft adapter is disclosed as a connecting piece that is removably attached to the end of a tuning shaft and secured in place with a fastener, such as a screw. The universal adapter features an interior contour that varies in size and/or shape to allow for the insertion of differently sized and shaped tuning shafts. This universal adapter also limits the rotation and/or movement of a separate cosmetic and/or functional piece (i.e., a customized tuning head).

The customizable tuning heads as well as the universal adapter features interchangeable functional and/or cosmetic components that allow for user-defined customization, including but not limited to material, shape, color, and design of the tuning heads (knobs, gears, keys, buttons) and the universal adapter. The disclosed adapter and system utilizes a universal tuning peg connector or adapter, where the tuning knob can be easily swapped or adjusted without compromising the instrument's tuning stability, performance, or changing the functionality of the instrument itself. The universal adapter contours perfectly to any stringed instrument using an interior contoured design, like that of a funnel. The universal adapter screws directly into the end of the tuning shaft/peg in place of the tuning head (key, button, knob, gear). Using magnetic technology, the tuning head is able to connect and remain attached to the tuning peg and universal adapter. The disclosed adapter and system allows for quick and easy accessorizing of a stringed instrument and allows the user to adjust their instrument how they see fit.

It should be understood that the above description, while indicating representative embodiments of the present disclosure, is given by way of illustration and not of limitation. Many changes and modifications may be made within the scope of the present disclosure without departing from the spirit thereof, and the present disclosure includes all such modifications.

Various additions, modifications, and rearrangements are contemplated as being within the scope of the following claims, which particularly point out and distinctly claim the subject matter regarded as the inventive concept, and it is intended that the following claims cover all such additions, modifications, and rearrangements.

One or more embodiments of the disclosure may be referred to herein, individually and/or collectively, by the term “invention” or “inventive concept” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

1. An adapter for a tuning shaft of a stringed instrument, the adapter comprising:
a body including:
a first opening disposed at a proximal end of the body, the first opening configured to receive the tuning shaft; and
a second opening disposed at a distal end of the body or on a portion of the body between the proximal end and the distal end, the second opening configured to receive a fastener for coupling the adapter to the tuning shaft,
wherein an outer surface of the body corresponds to an inner surface of a tuning head, such that the body is configured to at least partially nest within the tuning head.

2. The adapter of claim 1, the body further comprising:
an inner channel defined by an inner surface extending from the first opening to the second opening.

3. The adapter of claim 2, wherein the inner channel has a cross-sectional area that gradually reduces along at least a portion of the length of the inner channel from the first opening to the second opening.

4. The adapter of claim 1, wherein the first opening and the second opening are concentric.

5. The adapter of claim 1, wherein a cross-sectional area of the first opening differs from a cross-sectional area of the second opening.

6. The adapter of claim 1, wherein the body further comprises at least two proximally extending appendages.

7. The adapter of claim 6, wherein the first opening is a gap defined by a space between inner surfaces of the at least two proximally extending appendages.

8. The adapter of claim 6, wherein the at least two proximally extending appendages are configured to deflect in response to a proximally applied force at the distal end of the body.

9. The adapter of claim 8, wherein the at least two proximally extending appendages are further configured to generate a clamping force on the tuning shaft based on the proximally applied force.

10. The adapter of claim 6, wherein an axial translation of the fastener received by the second opening induces an elastic deformation of the at least two proximally extending appendages.

11. The adapter of claim 10, wherein the elastic deformation decreases the size of the first opening and applies a clamping force to the tuning shaft.

12. The adapter of claim 11, wherein a magnitude of the clamping force is directly proportional to a degree of the axial translation of the fastener.

13. The adapter of claim 1, wherein the distal end of the body is configured to be removably coupled with the tuning head by at least one of magnetic coupling, snap-fit coupling, twist and lock coupling, plug and play coupling, clip-on coupling, screw-on coupling, hook and loop coupling, suction coupling, or friction coupling.

14. A tuning head adapter assembly for a tuning shaft of a stringed instrument, the tuning head adapter assembly comprising:
a tuning head; and
an adapter configured to removably couple to the tuning head, the adapter comprising:
a body including:
a proximal end including a first opening configured to receive the tuning shaft; and
a distal end including a second opening configured to receive a fastener for coupling the adapter to the tuning shaft.

15. The tuning head adapter assembly of claim 14, wherein an outer surface of the body of the adapter corresponds to an inner surface of a cavity of the tuning head, such that the body of the adapter is configured to at least partially nest within the cavity of the tuning head.

16. The tuning head adapter assembly of claim 14, wherein the body further comprises:
an inner channel defined by an inner surface extending from the first opening to the second opening.

17. The tuning head adapter assembly of claim 16, wherein the inner channel has a cross-sectional area that gradually reduces along at least a portion of a length of the inner channel from the first opening to the second opening.

18. The tuning head adapter assembly of claim 14, wherein the body of the adapter further comprises at least two proximally extending appendages.

19. The tuning head adapter assembly of claim 14, wherein the adapter is configured to removably couple to the tuning head by magnetic coupling.

20. A tuning head adapter, the adapter comprising:
a first opening configured to receive a tuning peg; and
a second opening configured to receive a fastener for fastening the adapter to the tuning peg,
wherein an outer surface of the adapter corresponds to an inner surface of a cavity of a tuning head, such that the adapter is configured to at least partially nest within the cavity of the tuning head.
